(19) United States
(12) Patent Application Publication
(10) Pub. No.: US 2012/0330706 A1
(43) Pub. Date: Dec. 27, 2012

(54) WORKFORCE PLANNING TOOL METHOD AND SYSTEM

(75) Inventors: Dale R. Rabeneck, Coraopolis, PA (US); Richard C. Oppelt, Lawrenceville, GA (US); Subhashish Ray, Mumbai (IN)

(73) Assignee: Accenture Global Services Limited, Dublin (IE)

(21) Appl. No.: 13/459,876

(22) Filed: Apr. 30, 2012

(30) Foreign Application Priority Data
Jun. 22, 2011 (IN) 2111/CHE/2011

(51) Int. Cl. G06Q 10/06

(52) U.S. Cl. 705/7.13

(57) ABSTRACT

The workforce planning tool (WPT) decomposes, maps, and allocates historical cost center data of an organization, including personnel costs and non-personnel costs, to a process hierarchy used to identify target improvements. The WPT calculates baseline costs to operate the processes of the organization with no processing errors. The WPT calculates actual costs to operate the processes, and identifies an improvement target for the organization by comparing the baseline costs to the actual costs, and the historical cost center data of the organization.

### RELATED APPLICATIONS

This application claims priority to Indian Patent Application Serial No. 2111/CHE/2011, filed on Jun. 22, 2011, which is also incorporated herein by reference in its entirety.

### TECHNICAL FIELD

The present description relates generally to a system and method, for providing a workforce planning tool, and more particularly, but not exclusively, to identifying improvement targets for an organization that allow an organization to strategically meet resource requirements.

### BACKGROUND

Human capital may be a major source of competitive advantage for organizations. For example, studies have shown that human capital is the most important factor for maintaining an organization's competitive advantage in the marketplace over the long term. Thus, effectively managing a workforce of an organization to ensure sustained human capital may be important to organizations. However, a convergence of recent factors, such as expected changes in lifestyle, global economics, and labor pool shrinkage due to low birth rates, may render traditional systems ineffective for managing workforces within an organization.

### SUMMARY

The WPT includes a system for identifying the improvement targets for the organization. The WPT system includes a memory coupled to a processor. The memory includes historical cost center data of the organization, instructions executable by the processor that when executed by the processor cause the processor to capture historical cost center data of the organization, and map the costs of the organization to process hierarchy. The historical cost center data includes cost centers of the organization that the WPT system decomposes to allocate functional and departmental costs to the processes of the organization by determining, from the historical cost center data, for each cost center, unit cost center data, including personnel full-time equivalents (FTEs), personnel costs, and non-personnel costs, and allocating the unit cost center data to the corresponding processes of the organization. The WPT system calculates baseline costs to operate the processes of the organization with no processing errors, and actual costs to operate the processes of the organization. The WPT system calculates an actual-to-baseline gap value equal to the difference between the baseline costs and the actual costs, and that identifies the improvement target. The WPT system also includes a communications interface configured to receive, via a network, the historical cost center data of the organization into the memory and user interactions.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the claims below.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is logic flow that the workforce planning tool (WPT) may use to identify improvement targets.

FIG. 2 is a screenshot of an example WPT home page.

FIG. 3 is a partial screenshot of an industry segment drop down selectable menu on the WPT home page

FIG. 4 is a partial screenshot of a sub-offering drop down selectable menu on the WPT home page.

FIG. 5 is a screenshot of a landing page for the WPT for a specific Industry.

FIG. 6 is a screenshot of an example user selectable option to perform new survey.

FIG. 7 is a screenshot of an example WPT—Contact Page.

FIG. 8 is a screenshot of an example WPT—Choose Capability Page.

FIG. 9 is a flow diagram of an example target improvement hierarchy the WPT may use to allocate the costs of an organization.

FIG. 10 is a screenshot of an example WPT—Summary of selected sub-platforms.

FIG. 11 is a screenshot of an example WPT—Choose Process/Sub Process Page.

FIG. 12 is a screenshot of user selectable processes within a sub-platform of a capability.

FIG. 13 is a screenshot of an example WPT—Process Preview Page.

FIG. 14 is a screenshot of another example of a WPT—Process Preview Page.

FIG. 15 is a screenshot of an example WPT—upload employee and cost data.

FIG. 16 is a screenshot of example allocated full-time equivalent (FTE) personnel count details.

FIG. 17 is a screenshot of an example WPT—allocate cost page.

FIG. 18 is a screenshot of example percentages of costs allocated to selected processes of an organization.

FIG. 19 is a screenshot of an example WPT—report page.

FIG. 20 is a screenshot of an example WPT—report of costs by function.

FIG. 21 is a screenshot of another example WPT—report page.

FIG. 22 is a screenshot of an example WPT—report view of cost center information by process.

FIG. 23 is a screenshot of an example report view of cost center information by function.

FIG. 24 is a screenshot of another example report view of cost center information by function.

FIG. 25 is a screenshot of an example report view of cost center information by cc rollup function.

FIG. 26 is a screenshot of an example report view of cost center information by the processes of the organization.

FIG. 27 is a screenshot of an example report view of cost center information by process for a selected platform.

FIG. 28 is a screenshot of an example report view of cost center information by process for a selected sub-platform.

FIG. 29 is a screenshot of an example report by process.

FIG. 30 is a block diagram of an example system diagram of the WPT.

### DETAILED DESCRIPTION

The principles described herein may be embodied in many different forms. Not all of the depicted components may be required, however, and some implementations may include additional components. Variations in the arrangement and type of the components may be made without departing from the spirit or scope of the claims as set forth herein. Additional, different or fewer components may be provided.

The workforce planning tool (WPT) transforms the traditional look at personnel counts (e.g., full-time equivalents (FTEs)) and costs by organization unit to a process perspective. The WPT serves to break down organizational “silos” by generating a multimedia representation and graphical view of the costs according to the processes of the organization, identifies where multiple functions may interact in a business process. The multiple functions are from respective cost centers. Business processes may be unintentionally fragmented over multiple organizational units because of changes that occur to the processes over time, such as, due to responsibilities of personnel or non-personnel resources changing over time. Insufficient clarity of responsibility for business processes may lead to overlaps and redundancies by personnel and non-personnel resources that reflect in costs allocated to multiple costs centers. The WPT system may use Monte Carlo analysis techniques and methods to calculate baseline costs to operate the processes of the organization with no processing errors. The WPT system may calculate actual costs to operate the processes of the organization by applying the unit cost center data allocations to the processes. The WPT uses the overlaps and redundancies of personnel and non-personnel resources to identify improvement targets for the organization.

A system and method, generally referred to as a system, may relate to providing a workforce planning tool (WPT), and more particularly, but not exclusively, to identifying improvement targets for an organization that allow an organization to strategically meet personnel and non-personnel resource requirements. The principles described herein may be embodied in many different forms. The WPT system provides a way to analyze the costs of the organization at the business unit level, functional unit level, job family level, and/or regional level, in varying combinations together or separately, in view of the platform(s), sub-platform(s), capabilities, and/or processes employed by the organization, and vice versa analyze the platform(s), sub-platform(s), capabilities, and/or processes in view of the business units, functional units and sub-functional units, job families, and/or region. The WPT system may determine a baseline of costs of the processes and sub-processes of the organization by developing data about the processes and cost centers, generating or obtaining baseline costs by cost center, and mapping costs to processes and sub-processes. The WPT system calculates estimates for a change in the baseline costs by redesigning the platform, sub-platform, capabilities, processes, and/or sub-process.

The WPT system may develop and/or collect cost data that facilitates analyzing relative opportunities and improvement targets in various functions and processes. The organizational cost data may come from a combination of the financial department and the human resources department of the organization. Categories of costs include personnel count related and independent of personnel count. Costs should be grouped into categories such as labor, benefits, office space, and supplies. The WPT system enables the user to estimate the cost benefit of modifying workforce personnel resources to recognize personnel resource related costs that tend to vary directly with the number of personnel. The cost centers of an organization may include more, fewer or different combinations. The WPT system analysis may increase in accuracy with a greater granularity of cost centers are included, because the greater granularity enables improved span of control and ratio of staff to line type analysis. Not all categories of costs, such as direct materials, and operating supplies may be used by the organization. The WPT system distinguishes non-administrative costs from the base of administrative costs. The WPT system and/or the user may select a suitable time period (e.g., number of months, quarters, years) so that the base period is established long enough to smooth out fluctuations and adjusts for aberrations.

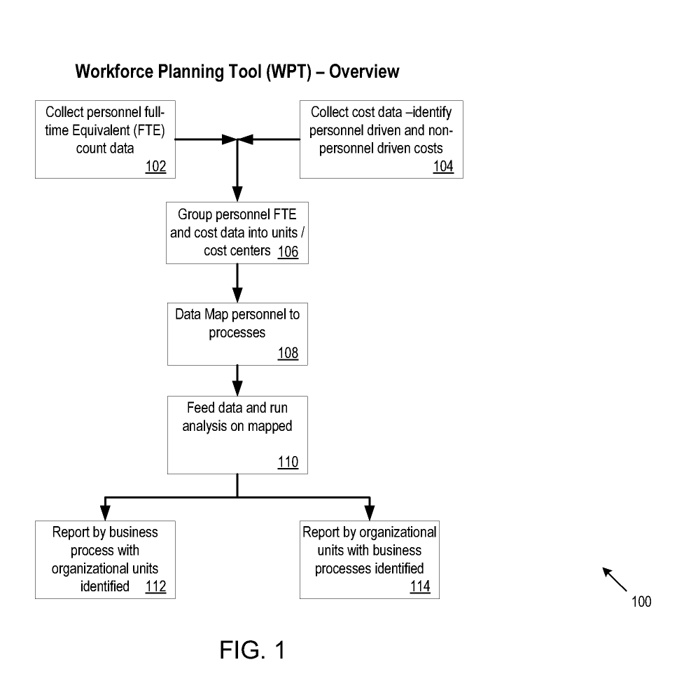

FIG. 1 is a flow chart of a logic flow 100 that the workforce planning tool (WPT) may use to identify improvement targets. Historical cost center data is collected (102), (104) including personnel full-time equivalent (FTE) head count data, personnel driven costs and non-personnel costs. Organizations traditionally collect costs according to major functions and sub-functions for cost centers of an organization. The finance and human resources functional areas typically provide the data for the organizational analysis, including the personnel and non-personnel costs. Levels of granularity of costs captured in the historical data, and levels of granularity of platform, sub-platform, and process components (e.g., scenarios, decision points, and logic branch) allocated the costs may determine more precisely and improve possible identification of process improvement targets.

The WPT identifies a user configurable process hierarchy for industries that includes platforms, sub-platforms, processes and sub-processes (e.g., scenarios, decision points, and logic branch). The WPT collects the costs of the costs centers for the organization to identify improvement targets, allocates and/or allows the user to allocate each cost center line item to the process that consumes the cost center resource (e.g., personnel and non-personnel). The WPT allocates costs to platforms, sub-platforms, capabilities, processes and sub-processes of the organization. The historical cost center data of the organization comprises unit costs for personnel costs and non-personnel costs to perform tasks for the organization The WPT groups the personnel FTE and cost data into unit cost center data (106) so that for each cost center the FTE count, personnel costs, and non-personnel costs are determined. The WPT maps and allocates the FTE count, personnel costs, and non-personnel costs for each cost center (e.g., unit cost center data) to the platform(s), sub-platform(s), capabilities, and/or processes of the organization (108). The WPT performs analysis on the processes in view of the costs as allocated to the processes (110). The WPT calculates baseline costs to operate the processes of the organization with no processing errors, and calculates actual costs to operate the processes of the organization using the unit cost center data allocation.

Calculating the actual costs by the WPT may further include conducting surveys to acquire addition information about the operations of the processes to more accurately calculate the actual costs to operate the processes. The WPT calculates an actual-to-baseline gap value that identifies the improvement target by comparing the baseline costs to the actual costs, where the actual-to-baseline gap equals the difference between the baseline costs and the actual costs, and identifies the improvement target when the actual-to-baseline gap value exceeds a user configurable threshold (e.g., an improvement target threshold value equal to a percentage of the baseline costs, or some factor of a standard deviation for the calculated value). The WPT generates reports that report the processes with the unit cost center data as allocated identified (112), and report the unit cost centers with the processes of the organization identified (114). The WPT may generate a multimedia representation and graphical view of the costs versus the platforms, sub-platforms, capabilities, and processes. The WPT may use a configurable procedure to map costs to processes. In order to generate a process view of costs, the WPT allocates costs, such as key costs, to process areas. Utilizing leads, the WPT and/or user identify the sub-processes executed within each cost center in each functional area. The WPT and/or user assign percentages of cost center costs that go to each of the sub-processes and/or processes in the following categories: employee and employee related costs, and outside service costs (e.g., not personnel related costs). Outside service costs may include costs for activities that have been outsourced to a third party. Examples of outsourced services range from payroll to project engineering.

Categories of costs include personnel count related and independent of personnel count data, salaries for managers and professionals, wages and salaries for clerical resources, benefits for managers and professionals, benefits for clerical resources, education and training costs, total before depreciation, depreciation, and a total after depreciation. The personnel count related data may include the sum of wages, salaries and benefits, communication costs, IT costs, space, rental, and supplies, travel and lodging, and the independent of personnel count data may include outside services, contributions, and other administrative costs.

The WPT system and/or the user may develop data to have a basis to assess economic value of changes and improvement targets. Many times ideas have low economic value because if implemented the idea results only in a reduction of annoyance costs. Data is developed in three general categories, including: Cost center data grouped into cost categories which enable identification of opportunities, separated into personnel driven costs and costs that are independent of personnel.

The WPT system and/or the user may develop data that includes personnel counts by cost center. The WPT system divides the counts of personnel into three groups: managers (only those that supervise people—used to evaluate spans of control), professionals (knowledge workers like engineers, lawyers, degreed accountants), and clerical. In addition, in many organizations distinctions are made between “white collar” and “blue collar” workers (also known as Salaried and Hourly or “THZ” and “R”). Often “blue collar” workers are utilized in administrative processes. Frequently different labor laws and rules apply depending upon the classification of workers. Sometimes additional designations are made whether the workers are represented by a union or non-represented.

Although there are typical measures of activity for an organization, to customize measures of activities, such as key measures of activities, for particular organizations, the WPT system provides the user a way to edit and supplement a standard list of measures with the measures used by the particular organization. Table 1 shows an example of measures of activities, such as key measures of activities. The values for the measures may not have to be precise, but the values for the measures correspond with the same time period that the cost and personnel count information was collected. For example, if the cost information is for the year 2005 annualized, the measures of activities are for the year 2005 annualized.

TABLE 1
Measures of Activities - Purchasing

1. Average number of purchase orders issued each month
2. Total number of active vendors
3. Average number of purchase requests for new items received each
month
4. Average number of purchase requests for repeat items received each
month
5. Average number of Request for Quotation issued each month
6. Number of SKU's maintained in stores (spare parts and supplies)
inventory
7. Number of commodity codes maintained

The historical cost center data of the organization includes unit costs for personnel costs and non-personnel costs to perform functions, sub-functions, and tasks for the organization. The WPT may use Monte Carlo analysis techniques and methods to calculate baseline costs to operate the processes of the organization with no processing errors (e.g., by applying Monte Carlo experiments at each component of the process hierarchy). Monte Carlo analysis techniques are stochastic techniques based on the use of random numbers and probability statistics to investigate problems. Monte Carlo methods (or Monte Carlo experiments) are a class of computational algorithms that rely on repeated random sampling to compute their results. Monte Carlo methods are often used in simulating physical and mathematical systems. Other analysis techniques may also be used.

Table 2 shows another method to capture and/or receive the baseline process view of costs is to allocate key costs to process areas/processes that consume the resources that incur the costs. this method, the key processes within each cost center in each functional area that should be executed is identified and the percentage of cost centre that goes towards execution of each of those processes is assigned in the following categories, including employee and employee related costs; and outside service costs (not personnel related costs).

TABLE 2
Cost Centre 1: Employee Costs = $100; Outside Costs = $ 100

| | | |
|---|---|---|
| | Employee and | Outside Service |
| Process Area 1 | Related Costs | Costs |

| | | | | |
|---|---|---|---|---|
| Process 1 | 10% | $10 | 10% | $10 |
| Process 2 | 20% | $20 | 10% | $10 |
| Process 3 | 40% | $40 | 30% | $30 |
| Process 4 | 30% | $30 | 50% | $50 |

The WPT system may calculate actual costs to operate the processes of the organization by applying the unit cost center data allocations to the processes that include at least one scenario that includes decision points and logic branches that include respective subsets of the decision points. The unit cost center data allocations to the processes may be further allocated to the at least one scenario, each of the decision points, and logic branches. The calculation of the actual costs to operate the processes includes calculations of the actual costs for the at least one scenario, each of the decision points, and logic branches. The multimedia representation and the graphical view of the costs according to the processes of the organization, include the baseline costs and actual costs to operate the processes of the organization decomposed for the at least one scenario, each decision point of the at least one scenario, and the logic branches of the at least one scenario. The user configurable threshold is a degree of defect threshold that indicates a degree of efficient or effective execution of the processes executed by the personnel resources and the non-personnel resources of the organization. The degree of defect threshold may alternatively, or in addition, indicate a degree of efficient or effective execution of the processes executed by the personnel resources and the non-personnel resources of the organization. The improvement target may be identified when process errors for the processes of the organization exceed a degree of defect threshold of a particular number of errors, a type of error that impacts quality of the processes of the organization, or a combination of the particular number errors and the type of error.

Table 3 shows example personnel and non-personnel unit cost calculations calculated using the historical cost center data.

TABLE 3
Unit Cost Calculations

((EmployeeCost/100) * SalariedSuper_Employees)
((EmployeeCost/100) * SalalriedProf_Employees)
((EmployeeCost/100) * SalariedClericalSupport_Employees)
((EmployeeCost/100) * TotalSalaried_Employees)
((ServiceCost/100) * Hourly_Employees)
((EmployeeCost/100) * TotalSalaried_Employees) +
((ServiceCost/100) * Hourly_Employees)
((EmployeeCost/100) * WagesSalaries_Summary)
((EmployeeCost/100) * SupervisionFixed_Charges)
((EmployeeCost/100) * Premiums)
((EmployeeCost/100) * FringeBenefits)
((EmployeeCost/100) * Wages_Salaries_Benefits)
((EmployeeCost/100) * FoodServices_OvertimeMeals)
((EmployeeCost/100) * Travel_Lodging_Memberships)
((EmployeeCost/100) * OfficeSupplies_Equipment)
((EmployeeCost/100) * SafetySupplies)
((EmployeeCost/100) * CommunicationCosts)
((EmployeeCost/100) * PersonalComputerCharges_Costs)
((EmployeeCost/100) * Office_Utilities)
((EmployeeCost/100) * SpaceCharges_Other)
((EmployeeCost/100) * EmployeeWelfare)
((EmployeeCost/100) * OtherPersonnelRelated)
((EmployeeCost/100) * TotalPersonnelRelated)
((ServiceCost/100) * OutsideServices_LegalAudit)
((ServiceCost/100) * OtherProfessionalServices)
((ServiceCost/100) * SellingExpenses)
((ServiceCost/100) * ITHardware_Services)
((ServiceCost/100) * Otherservices)
((ServiceCost/100) * Office_Utilities)
((ServiceCost/100) * ExternalServices)
((ServiceCost/100) * Production)
((ServiceCost/100) * Maintenance)
((ServiceCost/100) * OutsideProcessing)
((ServiceCost/100) * Production_Maintenance)
((ServiceCost/100) * TotalNonPersonal_Related)

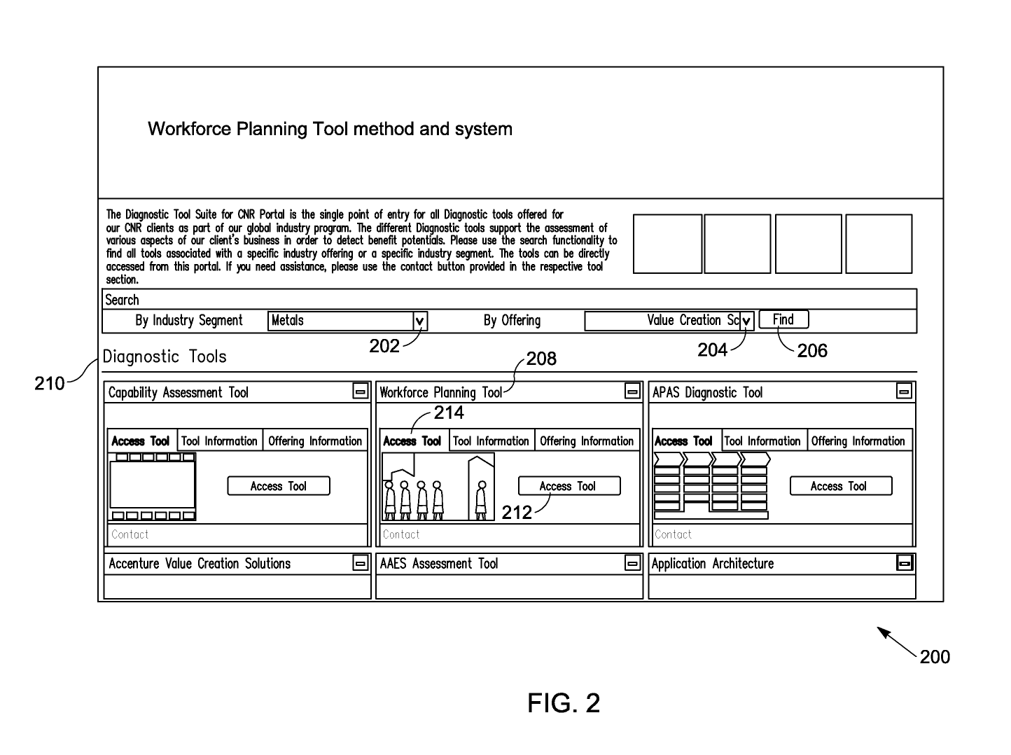

FIG. 2 is a screenshot of an example WPT home page 200. The user may select from user selectable drop down menus the industry segment 202 and/or sub-offering 204 from which to search for functionality and find 206 diagnostic tools usable for various industry segments and industry offerings. The WPT 208 may be a component of a diagnostic tool suite 210 used as a single point of entry for diagnostic tools useable as part of a global industry program for an organization. The different diagnostic tools support the assessment of various aspects of an organization's business in order to detect benefit potentials and/or improvement targets. Clicking on the “Access Tool” button 212 under the “Access Tool” tab 214 in order to access the WPT 208.

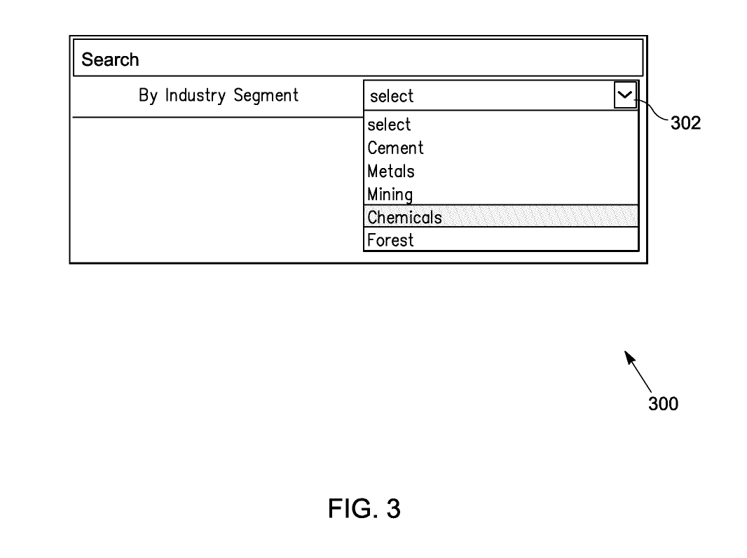

FIG. 3 is a partial screenshot of an industry segment drop down selectable menu 300 on the WPT home page 200. The industry segment drop down 302 displays the industries available for use with the WPT 208. The WPT 208 may activate the “Access Tool” button 212 when a user selects an industry in order for the user to proceed to the WPT 208.

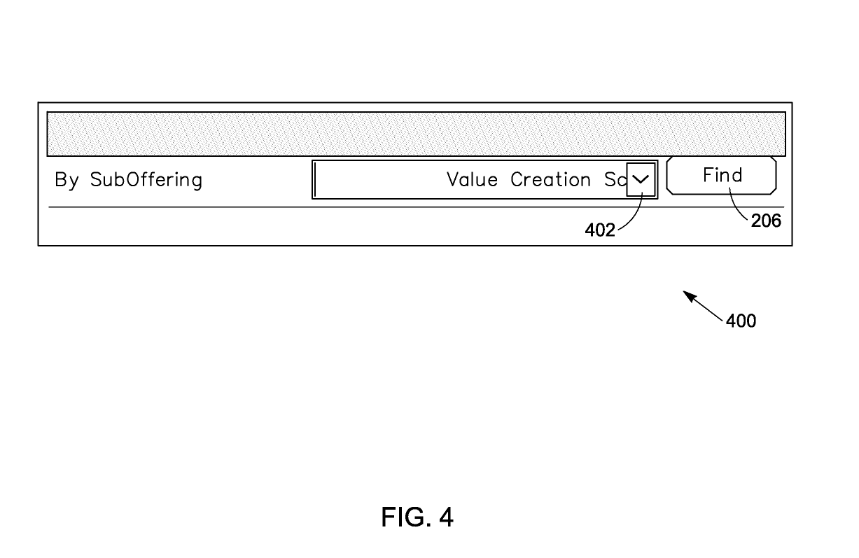

FIG. 4 is a partial screenshot of a sub-offering drop down selectable menu 400 on the WPT home page 200. The sub-offering drop down 402 allows the user to view the different tools available for application based on the option selected in the sub-offering drop down 402.

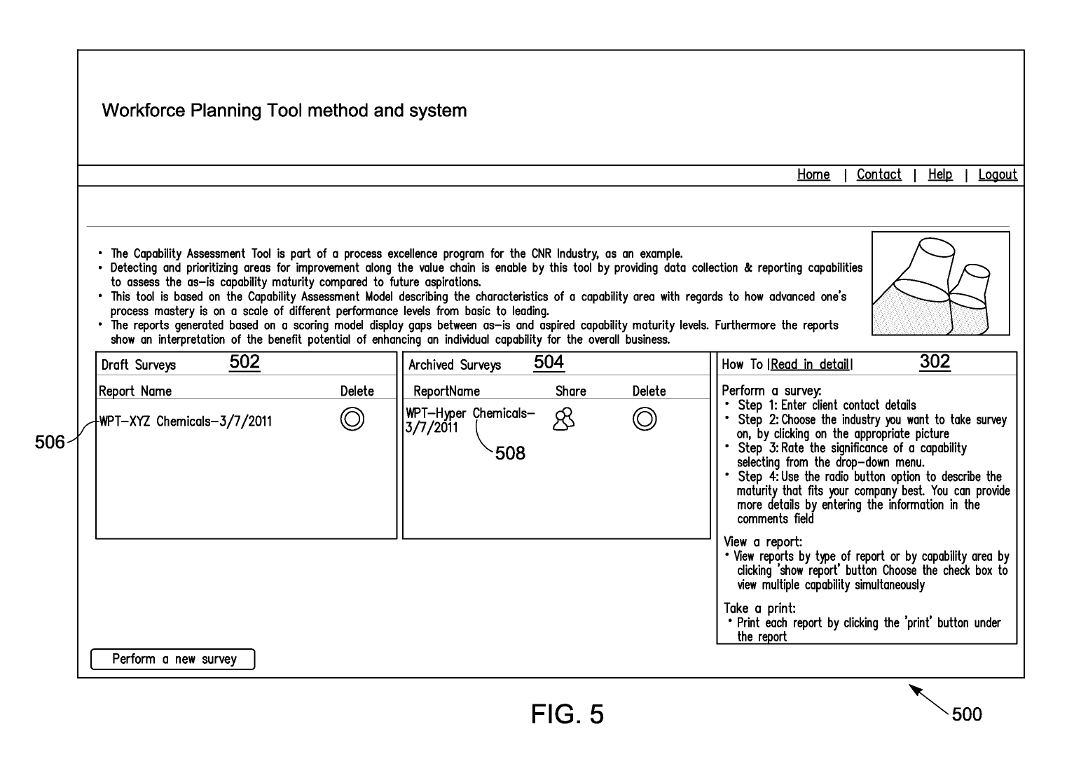

FIG. 5 is a screenshot of a landing page 500 for the WPT 208 for a selected industry 202. The WPT 208 navigates to the landing page 500 for the WPT 208 for a selected industry 202 when a draft survey 502 or archived survey 504 exists, and the user clicks on the “Access Tool” button 212 on the WPT home page 200. The landing page 500 displays the report names of incomplete and/or draft survey reports 506 and completed archived survey reports 508 for the selected industry 202. When the user clicks on the report name 506, 508 the WPT 208 redirects the user to the survey pages, discussed later below, in order to complete an incomplete draft survey and/or view an archived survey report. Once the draft surveys are completed and saved, the WPT 208 communicates the status of the surveys in the archived section. The archived survey displays the report names of completed and saved reports. The WPT 208 allows the user to share the archived report with other users.

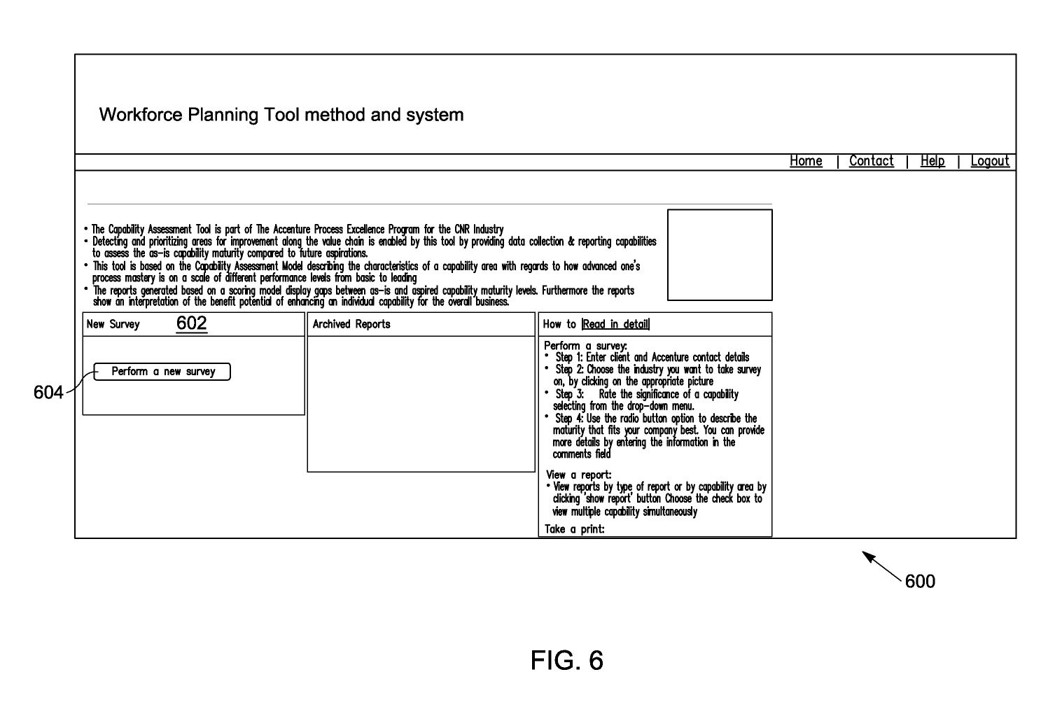

FIG. 6 is a screenshot of an illustration of another landing page 600 for the WPT 208 for a selected industry 202 that the WPT 208 may navigate to in order to create a new survey 602. The WPT 208 may navigate to landing page 600 in order to create a new survey when a draft survey 506 and archived survey 508 do not exist, and the user clicks on the “Access Tool” button 212 on the WPT home page 200. The landing page 600 includes a user selectable “perform a new survey” button 604 that when selected navigates the user to a WPT—contact page discussed later below. The WPT 208 navigates the user through the completion of the survey, which may include collecting contact details for the organization for which the WPT 208 may analyze the historical cost center data and processes. The WPT 208 prompts the user to choose the industry 202 in which to direct the new survey, and rate the significance of a capability of a platform and/or sub-platform. The WPT 208 may provide user selectable radio buttons for the user to describe the process maturity of the organization. The user may provide additional details by entering the information in comment field. The WPT 208 allows users to view reports by type of report or capability area. The user may choose to select to view multiple capabilities simultaneously.

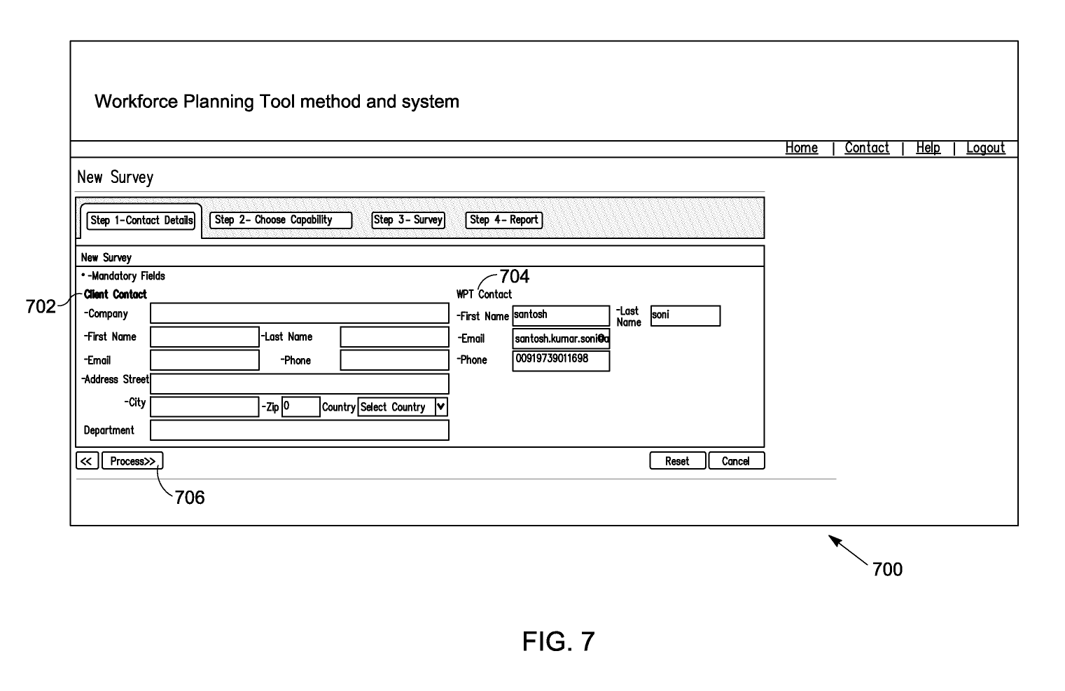

FIG. 7 is a screenshot of an example WPT—Contact Page 700 that the WPT 208 may navigate to when the user selects the user selectable “perform a new survey” button 604. The WPT—Contact Page 700 is the beginning page of the new survey. Detailed information about the client contact 702 is captured along with information about the client (e.g., organization) survey that is being performed, and the WPT contact 704 who may perform the survey and/or analysis of the organization with the WPT 208. The WPT 208 prompts the user to complete the client contact details. When the user clicks on the Proceed button 706, information regarding the client contact 702 and the WPT contact 704 is captured on this page, and may navigate the user to a WPT—choose capability page discussed below.

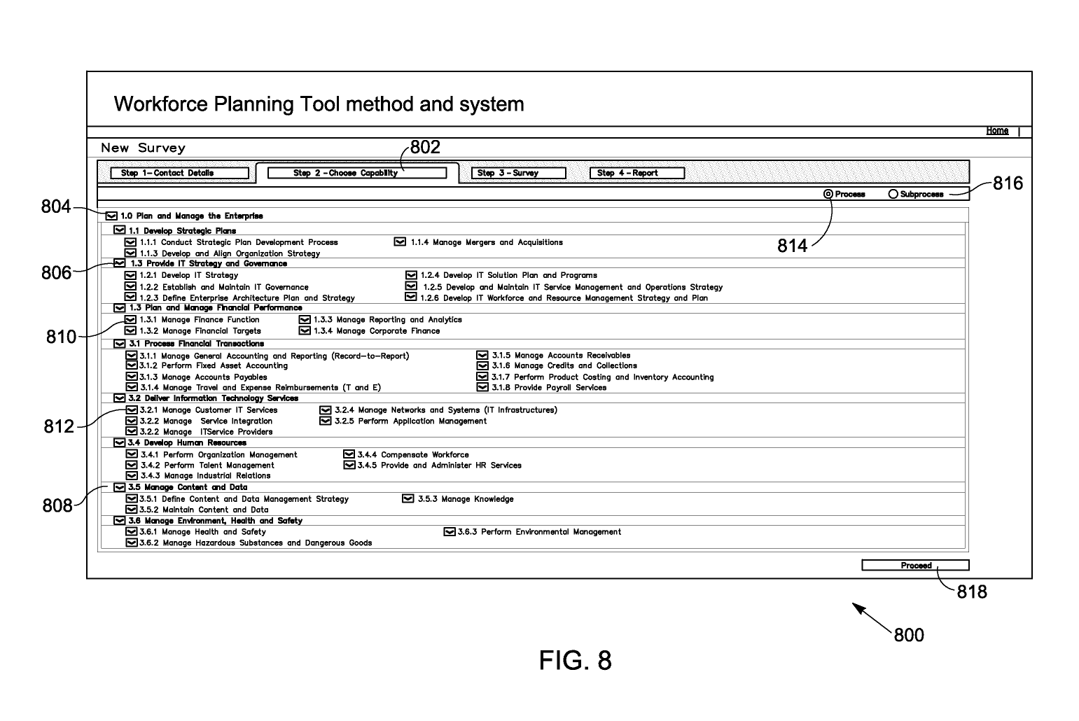

FIG. 8 is a screenshot of an example WPT—choose capability 800 page. Basic information regarding the functional scope for the assessment is captured on the WPT—choose capability 800 page. By default, for the choose capability step 802 the business process management (BPM) reference model platforms 804, sub-platforms (e.g., 806, 808), capabilities (e.g., 810, 812) and processes are selected. The WPT 208 prompts the user to uncheck sub-platforms, capabilities and processes that are not part of the assessment scope. The WPT—choose capability 800 page displays the sub-platform capability area and capabilities for each platform. The WPT—choose capability page 800 includes a user selectable option of selecting the process 814 option or sub-process 816 option. If the user selects the process 814 option, then the WPT 208 sets the hierarchy level for the survey to the process level. If the user selects the sub-process option, then the WPT 208 sets the hierarchy level for the survey to the sub-process level. If the user deselects the platform checkbox 804, then the WPT 208 deselects, and vice versa selects, the sub-platforms (e.g., 806, 808) and capabilities (e.g., 810, 812) under that platform hierarchy. If the user does not want any one of the sub-platforms or capabilities the user may deselect the check box and save the selections. If the user deselects the sub platform, the WPT 208 deselects the capabilities under that sub-platform hierarchy. The WPT 208 saves the sub-platforms and capabilities for the checkbox option checked or selected. Each platform, sub-platform, capability and process selection and metadata is saved in the database.

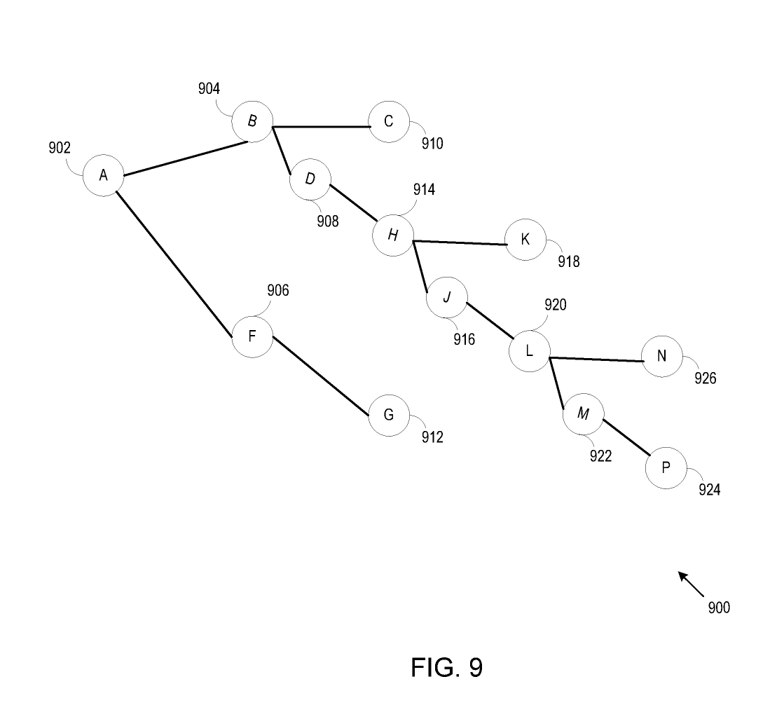

FIG. 9 is a flow diagram of an example target improvement hierarchy 900 the WPT 208 may use to allocate the costs of an organization. The target improvement hierarchy 900 include platforms 902, sub-platforms (904, 906), capabilities (908, 910, 912), and processes 914 that include scenarios, decision points 920, and logic branches (922-924 and 926). Processes comprise at least one scenario that includes an end-to-end path of decision points (e.g., 916-920-922-924) and logic branches (e.g., 922-924) that The WPT 208 allocates the costs. Levels of granularity of costs captured in the historical data and levels of granularity of process components (e.g., scenarios, decision points, and logic branch) used to allocate the costs may determine more precisely and easily improve identification of improvement targets.

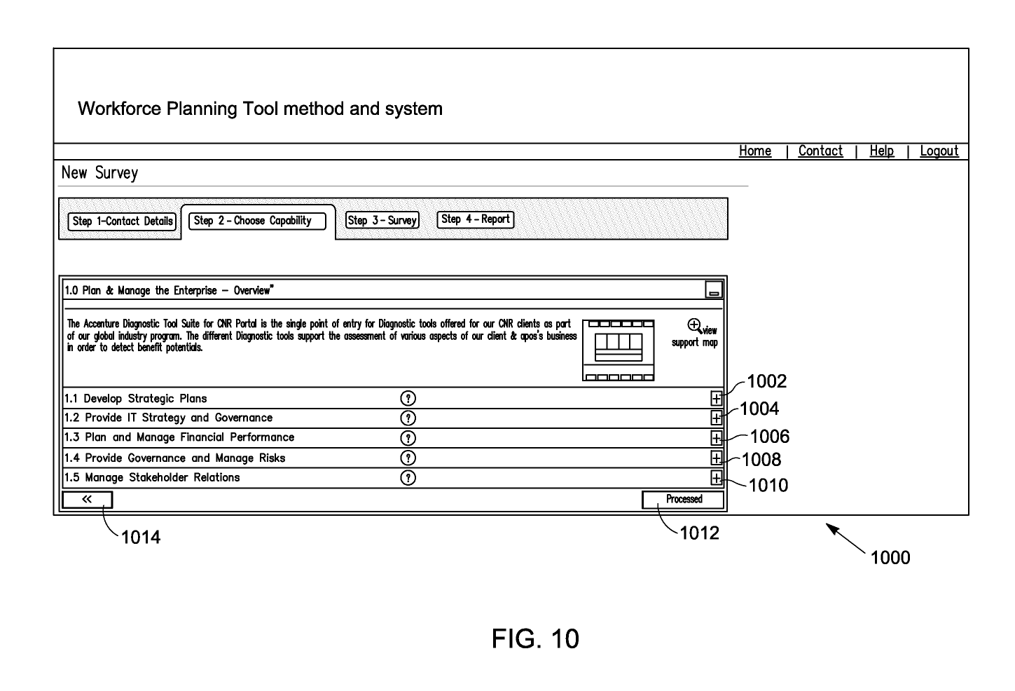

FIG. 10 is a screenshot of an example WPT—summary of selected sub-platforms 1000 for a selected platform. The user may select to expand or collapse (e.g., 1002, 1004, 1006, 1008, and 1010) the displayed sub-platforms to view the categories and processes under the sub-platforms. The user may click on the proceed button 1012 if everything is in order, else the user is prompted to click on the back 1014 button.

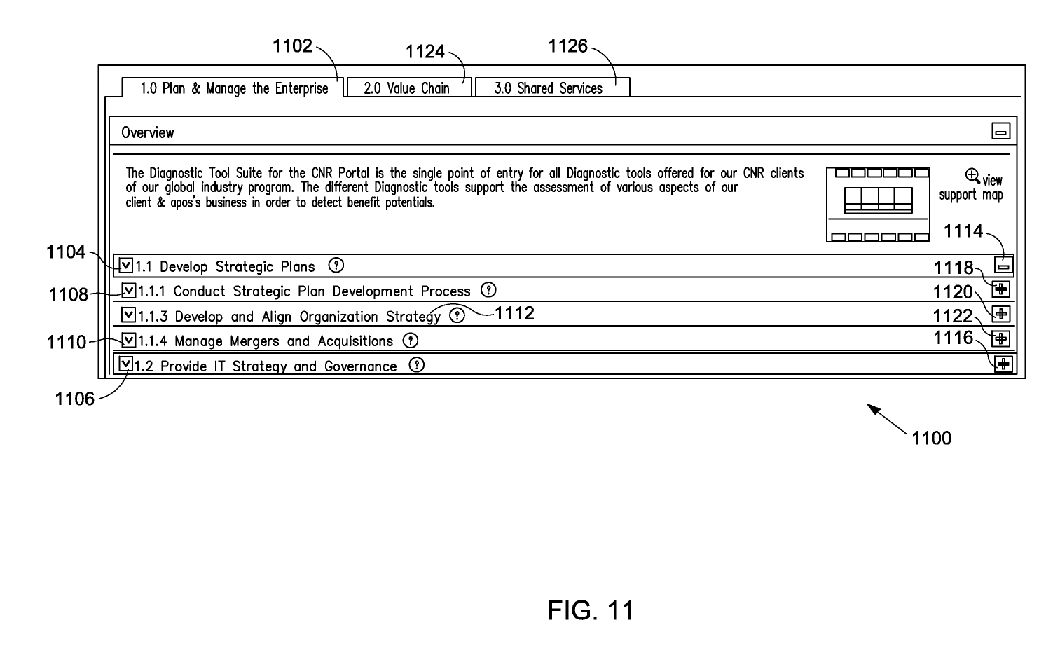

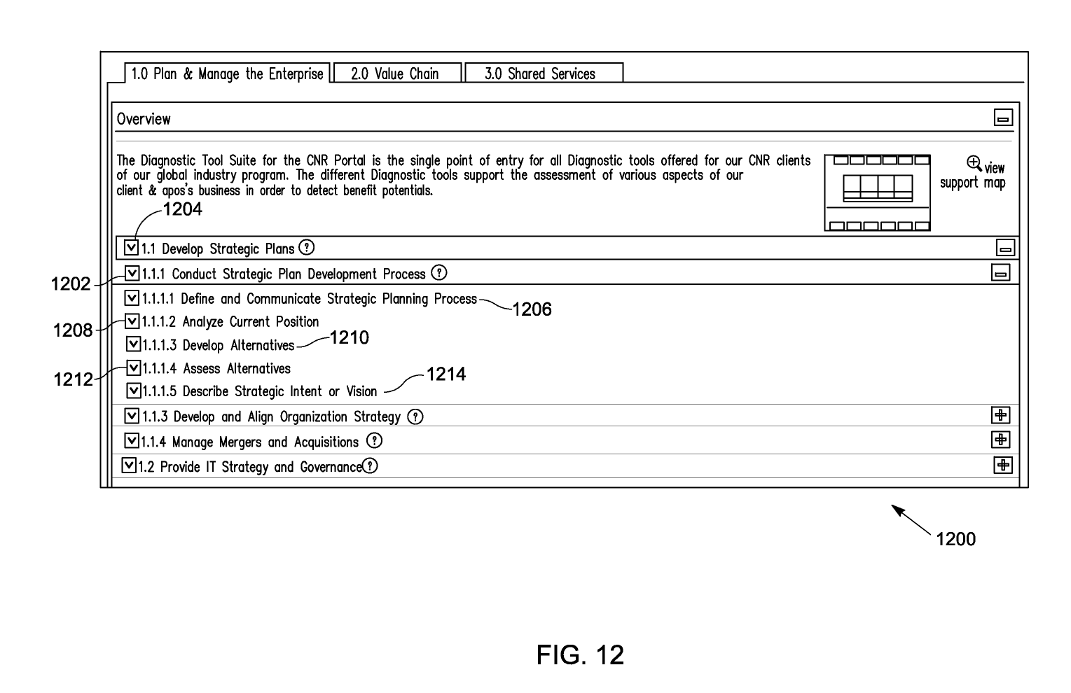

FIG. 11 is a screenshot of an example WPT—choose process/sub process 1100 page. When the user clicks the choose process/sub process button (814, 816), the choose process/sub-process 1100 page is displayed. The Tab 1102 that is not colored specifies that the user selected the platform identified by the Tab 1102 and the WPT 208 displays the sub-platform, capability, process/sub process details of the platform. The WPT—choose process/sub process 1100 page displays those sub-platforms (1104, and 1106) and capabilities (1108, 1110, and 1112) selected in the WPT—choose capability 800 page. When the user selects the collapse (1114, 1116) button for a sub-platform (1104, 1106), the WPT—choose process/sub process 1100 page displays the capabilities (1108, 1110, and 1112), selected in the WPT—choose capability 800 page, along with a checkbox against each capability allowing the user to select/deselect the capability if required. When the user selects the collapse (1118, 1120, 1122) button for capabilities (1108, 1110, and 1112), the WPT—choose process/sub process 1100 page displays the processes, sub-processes for which the checkbox option is checked or selected (as shown below in FIG. 12), selected in the WPT—choose capability 800 page. The WPT 208 analyzes the costs in view of the sub-platforms, capabilities, processes, sub-processes for which the checkbox option is checked or selected. The WPT 208 stores the analysis and each selected platform, sub-platform, capability, process, and sub-process saved in the database. After saving the data for one platform 1102, the WPT 208 navigates the user to the second platform 1124 (e.g., 2.0 Value Chain Tab). Saving the data for the second platform 1124, the WPT 208 navigates to the third platform 1126 (e.g., 3.0 Shared Services Tab). Once the data is saved for the third platform 1126, the WPT 208 may direct the user to the next survey page (e.g., see below edit process/sub-process 1410, and edit sub-platform/capabilities 1412).

FIG. 12 is a screenshot of user selectable processes 1200 within a capability 1202 of a sub-platform 1204. The WPT 208 displays each process under the capability hierarchy along with a checkbox for the user to select or deselect the processes (1206, 1208, 1210, 1212, and 1214). The WPT 208 by default selects or checks the checkboxes of the processes (1206, 1208, 1210, 1212, and 1214) of the capability hierarchy.

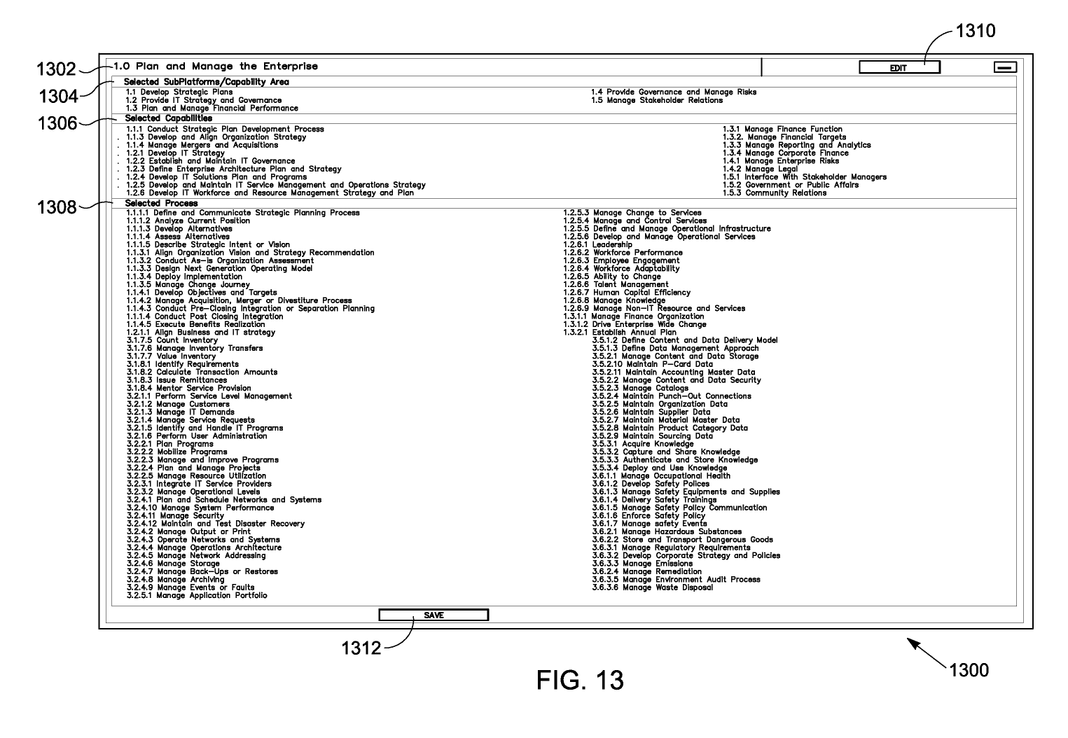

FIG. 13 is a screenshot of an example WPT—process preview 1300 page. The WPT—process preview 1300 page displays a preview popup of selected platforms 1302, sub-platforms 1304, capabilities 1306 and processes 1308 that the user may modify by clicking on the edit 1310 button. When the user clicks on the edit 1310 button the WPT 208 navigates to the corresponding page. When the user completes the edits, the user may click the save 1312 button to save the modifications.

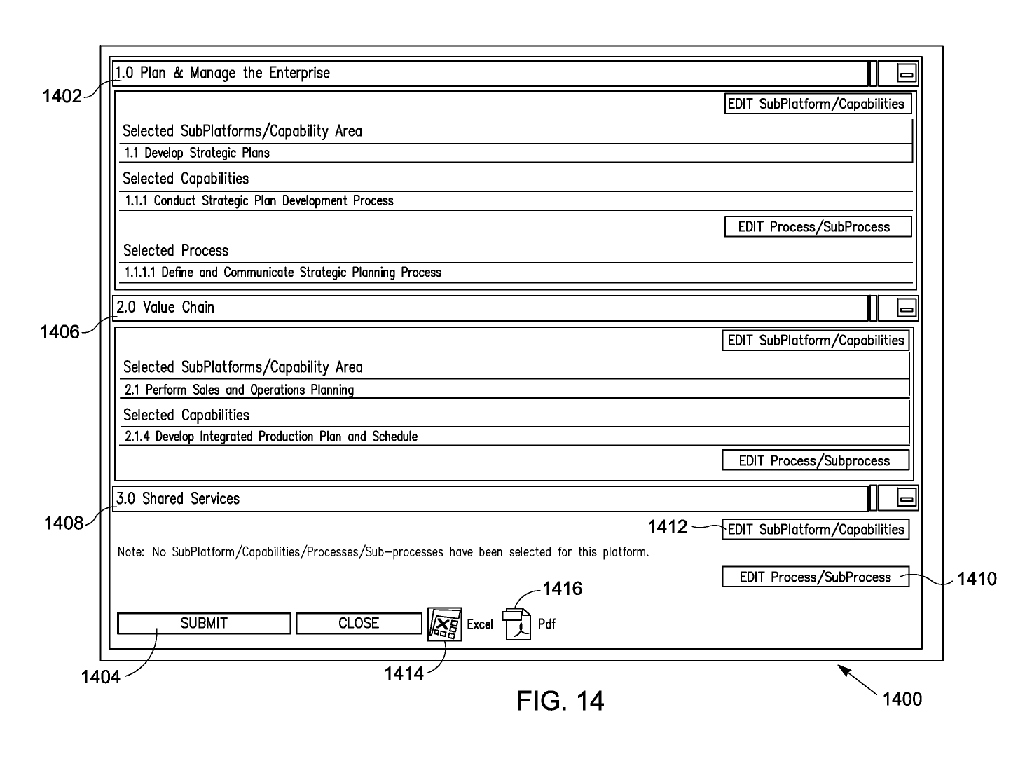

FIG. 14 is a screenshot of another example of a WPT—process preview 1400 page. After saving the data for one platform 1402, when the user selects the “submit” 1404 button the WPT 208 navigates the user to the second platform 1406 (e.g., 2.0 Value Chain Tab). Saving the data for the second platform 1406, the WPT 208 navigates to the third platform 1408 (e.g., 3.0 Shared Services Tab). Once the data is saved for the third platform 1408, the WPT 208 will direct the user to the next survey page (e.g., edit process/subprocess 1410, and edit sub-platform/capabilities 1412). The WPT 208 displays no sub-platform, capabilities, processes, or sub-processes for a particular platform (e.g., 1408), when the user selects no sub-platform, capabilities, processes, or sub-processes for the particular platform (e.g., 1408). The WPT—process preview 1400 page displays the selected sub platforms, capabilities, processes, sub processes selected by the user, and allows the user to modify the sub platforms, capabilities, processes, and sub-processes by clicking on the edit sub-platform/capabilities 1412/and edit process/subprocess 1410 buttons for each platform. The WPT 208 directs the WPT—process preview 1400 page to the choose capability page or choose process/subprocess page during the edit mode. When the user selects the submit 1404 button, the WPT 208 saves or updates the processes selected and redirects the page to the next survey page (upload employee and cost data). Button will close the page and redirects the page to the next survey page (upload employee and cost data). The WPT 208 provides user selectable download options (1414, 1416) to download process preview content in an Excel formatted file and/or in a PDF format.

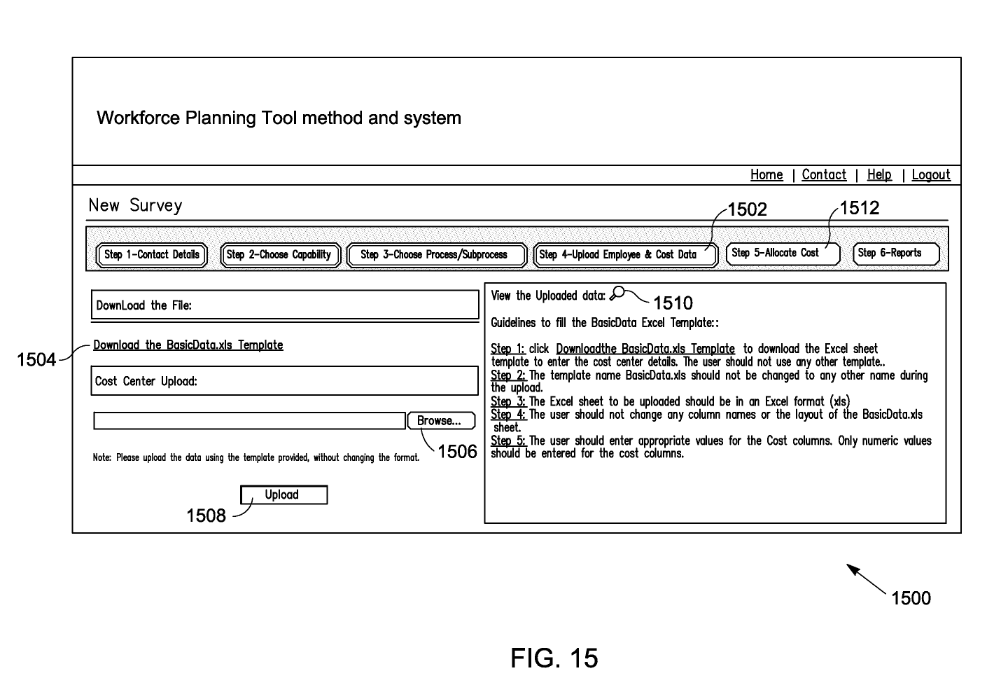

FIG. 15 is a screenshot of an example WPT—upload employee and cost data 1500 page. When the user clicks the upload employee and cost data 1502 button, the WPT 208 displays the upload employee and cost data 1500 page. The WPT 208 allows the user to download a basic data file 1504 (e.g., MS-Excel™ spreadsheet) in order to input cost center and other detailed information. The download a basic data file 1504 button (e.g., hyper-link) when clicked allows the user to download the excel template usable to input the cost centre details. The user may browse 1506 and select a completed basic data file saved on a computer hard disk or other form of computer memory. The WPT 208 allows the user to upload the cost center details from the data file to the WPT 208 when the user clicks on the upload 1508 button. The user may view the data which was uploaded by selecting the view uploaded data view finder 1510 icon hyper-link. When the user clicks the allocate costs 1512 button, the WPT 208 loads the cost centre details from the excel sheet to the WPT database and redirects the user to the next survey page (e.g., a WPT—allocate cost 1700 page).

For each cost center, data is captured in the baseline data file at the cost center (CC) rollup function and sub-function levels. The baseline data file includes, for each cost center, the rollup function and/or sub-function, a brief description of the cost center and/or the function, and sub-function. The baseline data file includes, for each cost center, salaried workers' headcount information, including the number of supervisors, professionals, clerical, and support employees, and hourly workers' headcount information including the number of hourly workers. The total personnel related costs equal the sum of the personnel wages, salaries, benefits and other personnel related costs. The personnel wages, salaries, and benefits costs, includes supervision and fixed charges, premiums, and fringe benefits. The count of personnel and the costs associated with those personnel may be related to the extent possible, recognizing that counts of personnel are often taken at a point in time, where in contrast costs are accumulated over time. Counts of personnel are often taken by computing based on full-time equivalents (FTEs) in order to recognize part-time workers and shared positions. An average compensation for personnel for each cost center and the CC rollup function and/or sub-function equals the sum of the personnel wages, salaries, and benefits costs divided by the sum of the headcount number of salaried workers and hourly workers. The other personnel related costs may include food services and overtime meals, travel, lodging and memberships, office supplies and equipment, safety supplies, communication costs, personal computer charges and costs, office utilities, space charges—other (e.g., real estate), and employee welfare. The total non-personal related costs equal the sum of the external services costs, the production and maintenance costs, and other non-personal related costs. The external services costs include outside services (e.g., legal and audit), other professional services, selling expenses, information technology hardware and services, and other services. The production and maintenance costs include production, maintenance, and outside processing costs. The other non-personal related costs may include direct and storeroom supplies, leases and overhead charges, training and recruitment, taxes, other fees, and insurance. The total costs to an organization for each cost center and CC rollup function/sub-function equals the sum of the total personnel related costs and the total non-personnel related costs, combined with the depreciation, materials, and other identified costs. More, fewer or different combinations of costs may be used to determine the total costs to an organization for each cost center and CC rollup function/sub-function.

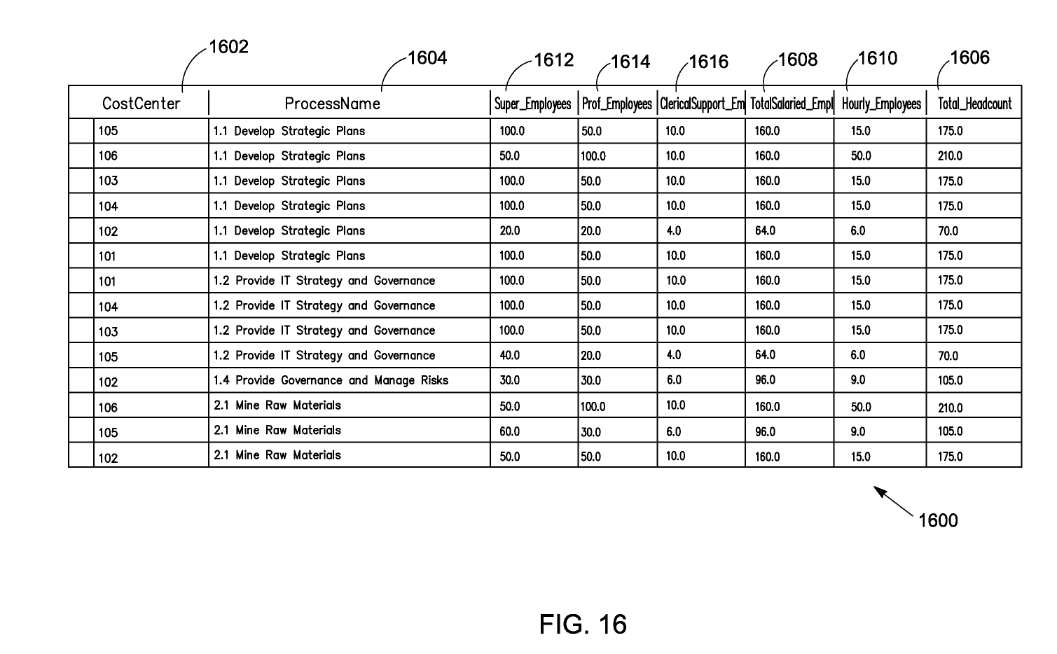

FIG. 16 is a screenshot of example allocated full-time equivalent (FTE) personnel count details 1600. The allocated FTE personnel count details 1600 may identify, for each cost center 1602 allocated to a process 1604 name, the total head count 1606 allocated to the process for the cost center. The total head count 1606 equals the sum of the number of salaried employees 1608 and the number of hourly workers 1610. The number of salaried employees 1608 may include supervisors 1612, professionals 1614 and clerical and support employees 1616. The WPT 208 determines, for each process 1604 name, unit cost center data by applying the allocated FTE personnel count details 1600 to the costs allocated to the respective cost center 1602, discussed in detail below.

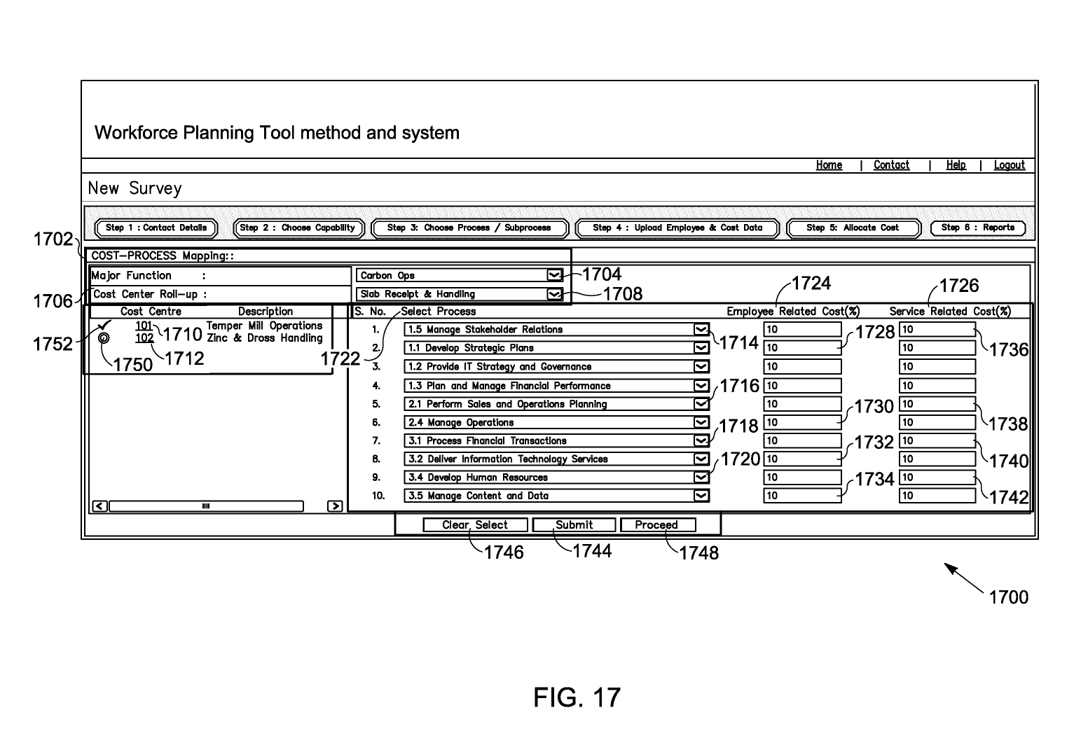

FIG. 17 is a screenshot of an example WPT—allocate cost 1700 page. The WPT—allocate cost 1700 page allows the user to map the cost centre costs to the processes of the organization, and allocate the costs against each process. The user may select a major function 1702 of a cost center from a dropdown menu 1704, and a sub-function 1706 from dropdown menu 1708. The major function drop down list displays the major functions of the organization as uploaded to WPT database. When the user clicks on the cost center list (1710, 1712), the WPT 208 loads, into memory, the data from the uploaded basic data file. The user may select from the pull down menus (1714, 1716, 1718, 1720), located under the ‘select process’ 1722 heading, user selectable platforms, sub-platforms, capabilities and processes to allocate personnel and non-personnel costs. The WPT 208 may provide suggested and/or the user may input the employee related costs 1724 in percentages (%) for each selected platform, sub-platform, capability and process. The WPT 208 includes a system check that causes the WPT 208 to prompt the user with message text or audio to modify one or more percentage values (e.g., 1728, 1730, 1732, and 1734) so that the user entered employee related cost percentage total does not exceed 100% of the total actual employee related costs. The WPT 208 may provide suggestions and/or the user may input the service related costs 1726 in percentages (%) for each selected platform, sub-platform, capability and process. The WPT 208 includes a system check that causes the WPT 208 to prompt the user with message text or audio to modify one or more percentage values (e.g., 1736, 1738, 1740, and 1742) so that the user entered service related cost percentage total does not exceed 100% of total service related costs. When the user clicks on the submit 1744 button the WPT 208 applies the employee related cost 1724 and service related cost 1726 percentage allocations to the unit cost center data to calculate the costs of each selected platform, sub-platform, capability and process. The user may clear the selected percentage allocations by clicking on the ‘clear select’ 1746 button. Once the user has submitted percentage allocations, the user may click the ‘proceed’ 1748 button to navigate to reports.

The CC rollup dropdown displays those cost centre Roll Up's under the selected Major function (e.g., 1704). The data in the cost centre Roll Up varies based on the Major Function selected. When the “cost centre roll up” is selected the WPT 208 displays the cost center information for cost centers (1710, 1712) under the selected “cost centre roll up” 1706. The cost center information includes the cost centre name and description. The WPT 208 may use a particular colored icon 1750 (e.g., a red circle) displayed for each cost centre that indicates the processes have not been mapped and the costs of the cost centre have not been allocated. Once the processes have been mapped and costs have been allocated, the red mark (e.g., 1750) is changed to green tick mark (e.g., 1752). When the user clicks a cost center (1710, 1712), the WPT 208 displays a user configurable number of multiple dropdown list boxes loaded with the selected processes (1206, 1208, 1210, 1212, and 1214). The WPT 208 allows the user to select the process from the drop down list (e.g., 1714, 1716, 1718, and 1720). The WPT 208 does not include as a selectable value, in a currently selected dropdown, a value previously selected from a previously selected dropdown.

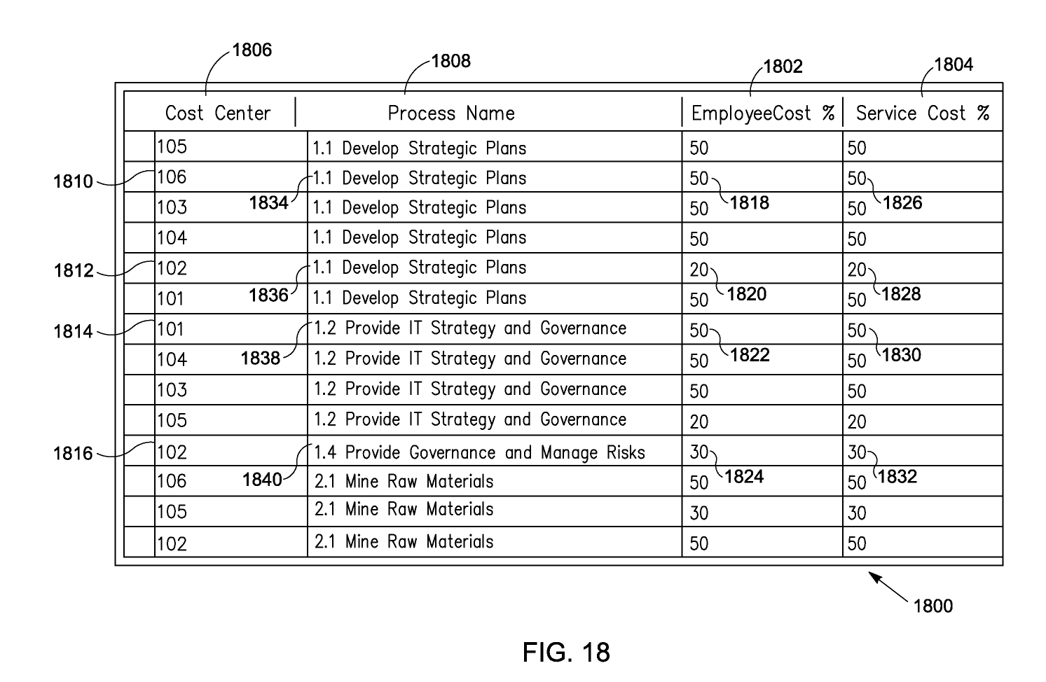

FIG. 18 is a screenshot of example percentages 1800 of employee related costs 1802 and service related costs 1804 of a cost center 1806 allocated to selected processes 1808. For each costs center (e.g., 1810, 1812, 1814, and 1816), the sum of the user entered employee related cost percentages (e.g., 1818, 1820, 1822, and 1824) and service related cost percentages (e.g., 1824, 1826, 1828, and 1830) for a selected process (e.g., 1832, 1834, 1836, and 1838) does not exceed 100%. The WPT 208 includes a system check that causes the WPT 208 to prompt the user with message text or audio to modify one or more of the combination of the employee related cost percentages (e.g., 1818, 1820, 1822, and 1824) and service related cost percentages (e.g., 1826, 1828, 1830, and 1832) for a selected process (e.g., 1834, 1836, 1838, and 1840) so that the sum of the user entered employee related cost percentages and related cost percentages, for a selected process, does not exceed 100%.

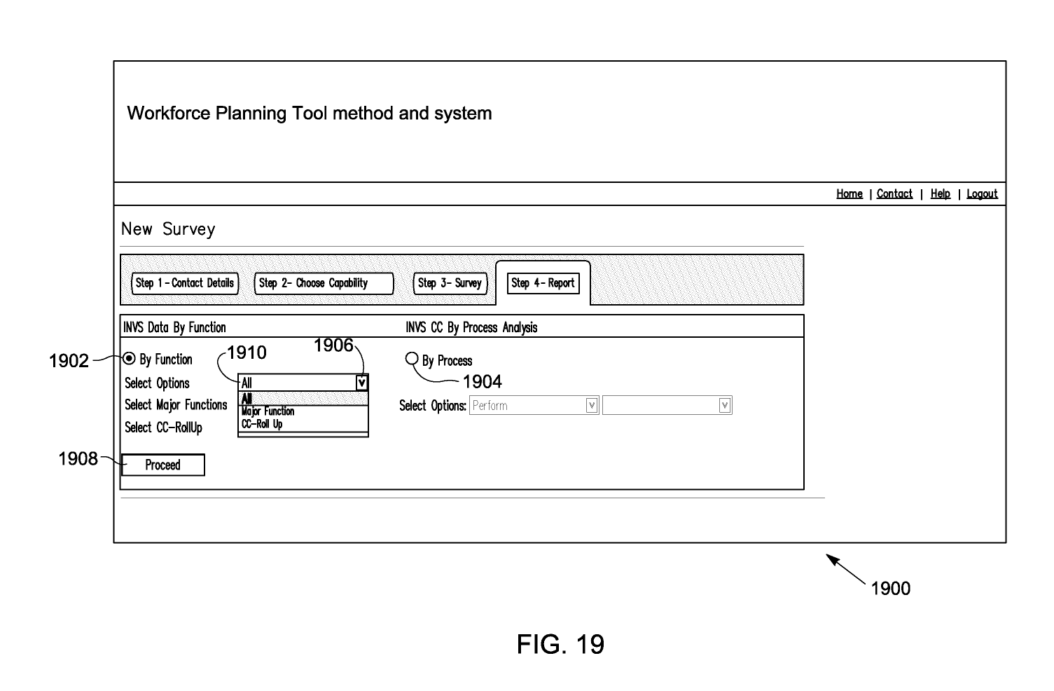

FIG. 19 is a screenshot of an example WPT—report 1900 page. The user may toggle between radio buttons (1902, 1904) to view reports by function or by process. The WPT 208 defaults to select to view reports by function. The WPT 208 provides user selectable reporting options selectable from dropdown list 1906. When the user clicks on the proceed 1908 button, the WPT 208 analyzes the by function generate reports in 3 ways, namely: a) a report can be generated based on each Major Function, b) a report can be generated based on each CC Roll up, and c) a report can be generated regardless of the Major function or the CC Roll up, using the “ALL” 1910.

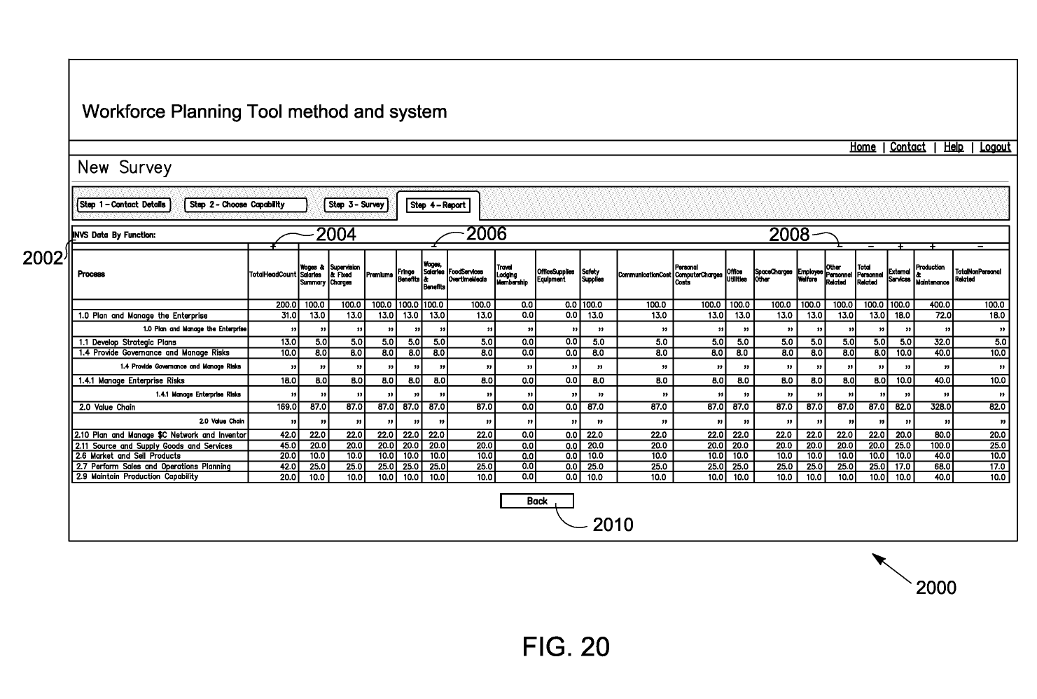

FIG. 20 is a screenshot of an example WPT—report 2000 of costs by function 2002. The user may expand the nodes (e.g., 2004, 2006, 2008) to view the column details, and the expand nodes to view the row details. When the user clicks on the back 2010 button to go back to previous screen to change the reporting selection.

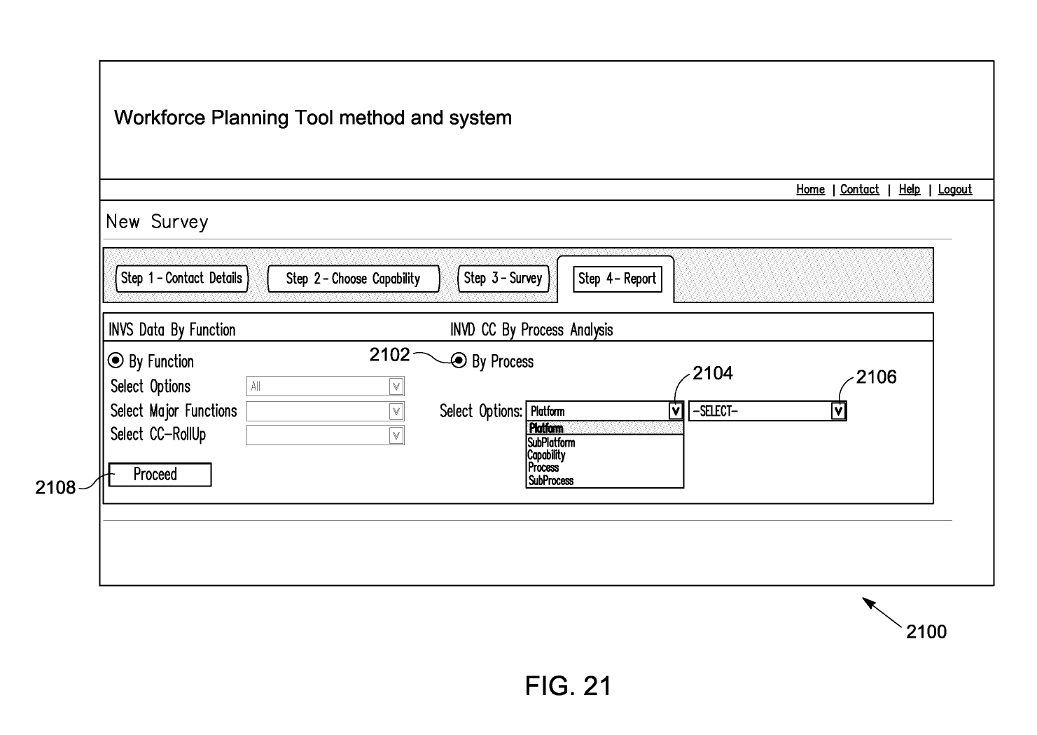

FIG. 21 is a screenshot of another example WPT—report 2100 page. The user may click on the ‘By Process’ 2102 radio button to view reports by process. The user may select the reporting options for the by process view from the 2104 dropdown menu, including reporting platform, sub-platform, capability, process, sub-process selected. The user may select the available sub-options 2106 based on the selection. When the user clicks on the proceed 2108 button, the WPT 208 analysis by Process generates reports based on the Platform, Sub Platform, Capability, Process, Sub Process selected from the 2104 dropdown menu.

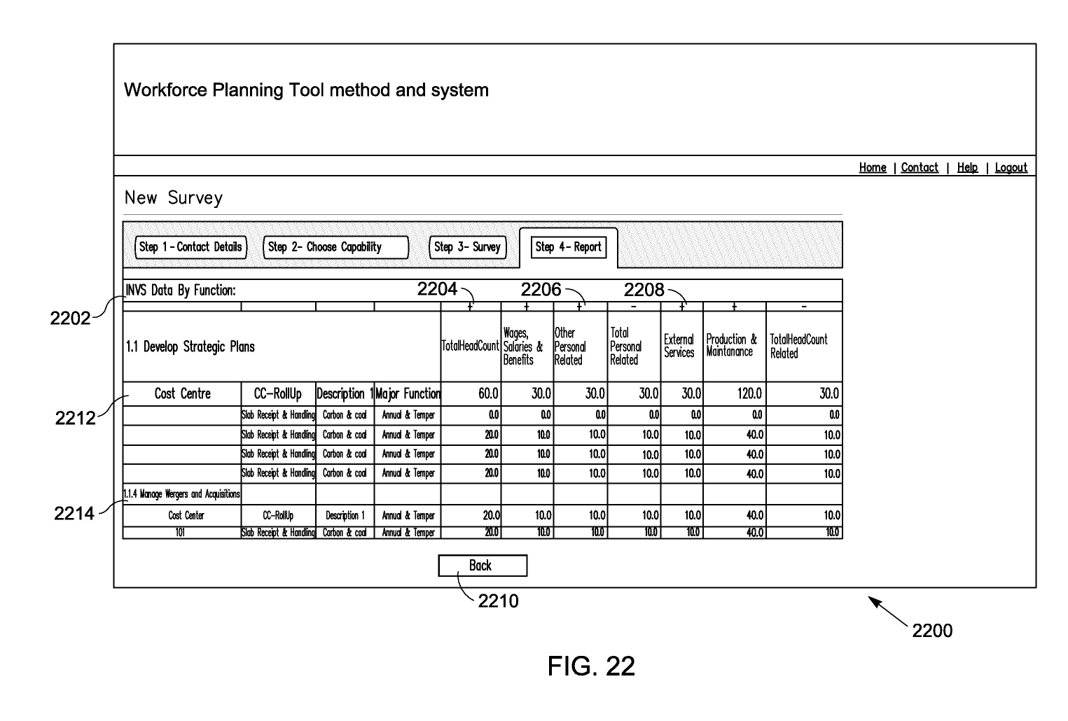

FIG. 22 is a screenshot of an example WPT—report view 2200 of cost center information by process 2202. The user may expand the nodes (2204, 2206, and 2208) to view the column details. The user may click on the Back 2210 button to go back to previous screen. The report view 2200 of costs allocated by process 2202 shows the cost center 2212 information (e.g., the CC rollup function and/or sub-function) including capabilities 2214 details.

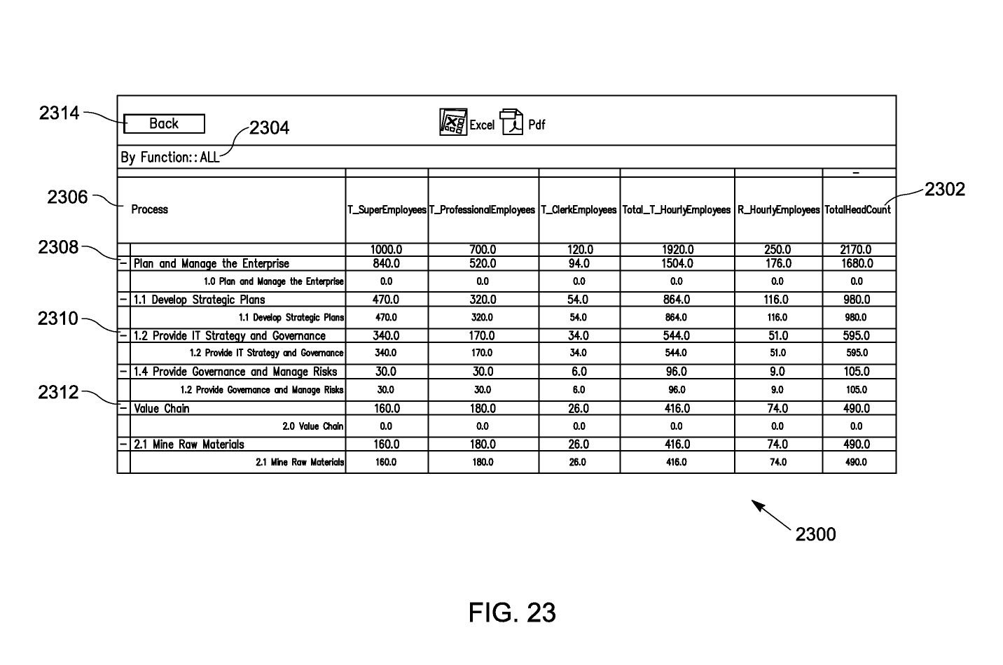

FIG. 23 is a screenshot of an example report view 2300 of cost center information 2302 by function 2304 as allocated to the processes 2306. The user may expand the hierarchy of nodes (2308, 2310 and 2312) to view each of the platforms, sub-platforms details. The user may click on the Back 2314 button to go back to previous screen.

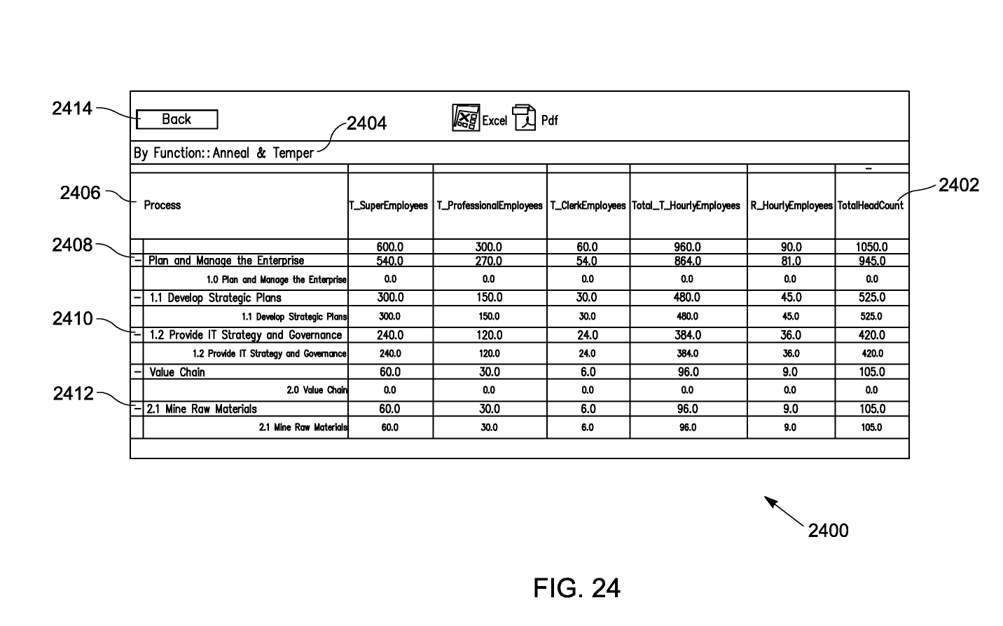

FIG. 24 is a screenshot of another example report view 2400 of cost center information 2402 by function 2404 as allocated to the processes 2406. The user may expand the hierarchy of nodes (2408, 2410 and 2412) to view each of the platforms, sub-platforms details. The user may click on the Back 2414 button to go back to previous screen.

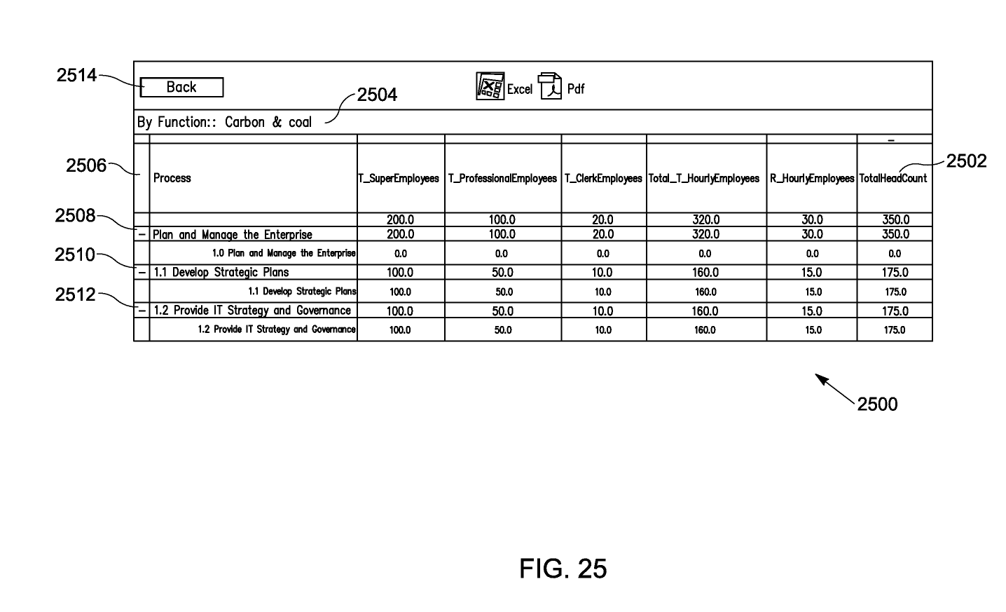

FIG. 25 is a screenshot of an example report view 2500 of cost center information 2502 by cc rollup function 2504 as allocated to the processes 2506. The user may expand the hierarchy of nodes (2508, 2510 and 2512) to view each of the platforms, sub-platforms details. The user may click on the Back 2514 button to go back to previous screen.

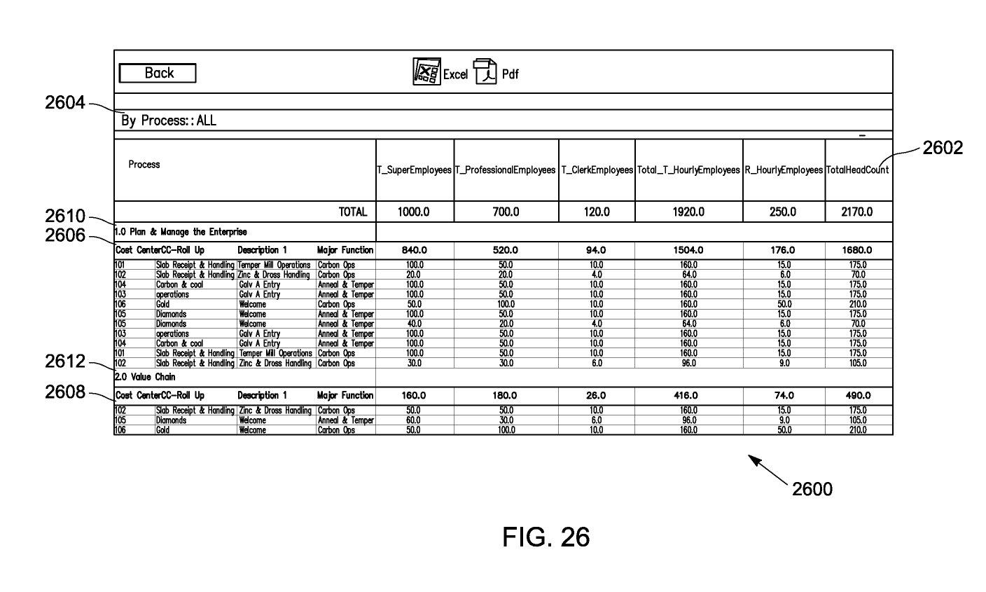

FIG. 26 is a screenshot of an example report view 2600 of cost center information 2602 by the processes 2604 of the organization. The user may view cost center details (2606, 2608) as allocated to each platform (2610, 2612), and sub-platform.

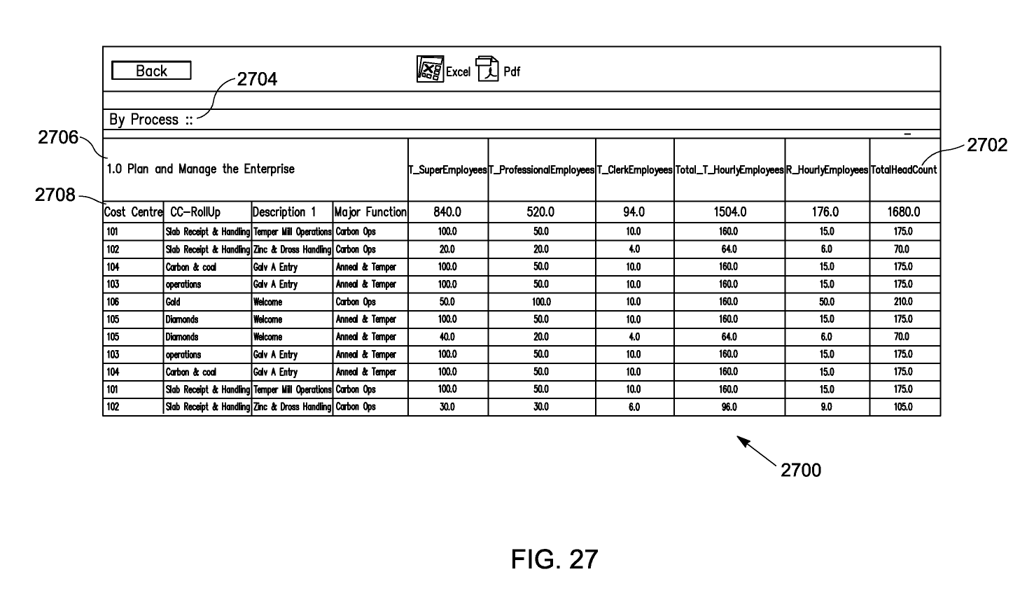

FIG. 27 is a screenshot of an example report view 2700 of cost center information 2702 by process 2704 for a selected platform 2706. The user may view cost center details 2708 as allocated to the platform 2704.

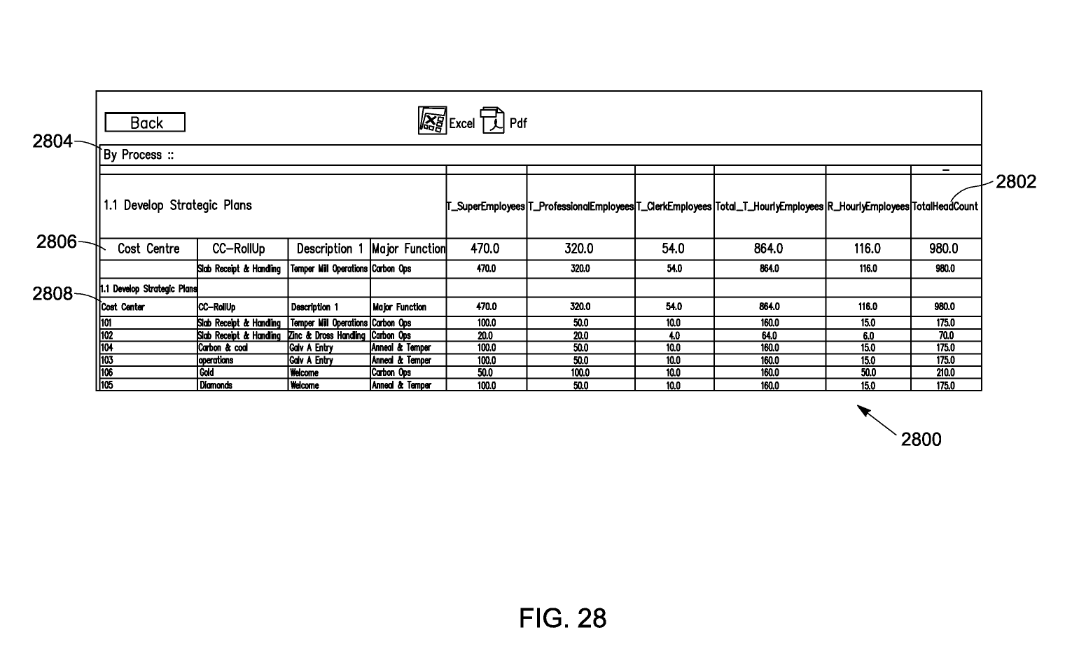

FIG. 28 is a screenshot of an example report view 2800 of cost center information 2802 by process 2804 for a selected sub-platform 2806. The user may view cost center details 2808 as allocated to the sub-platform 2806. The report view 2800 reports allocated cost center information 2802 allocated to each capability, process, and sub-process for the sub-platform 2806.

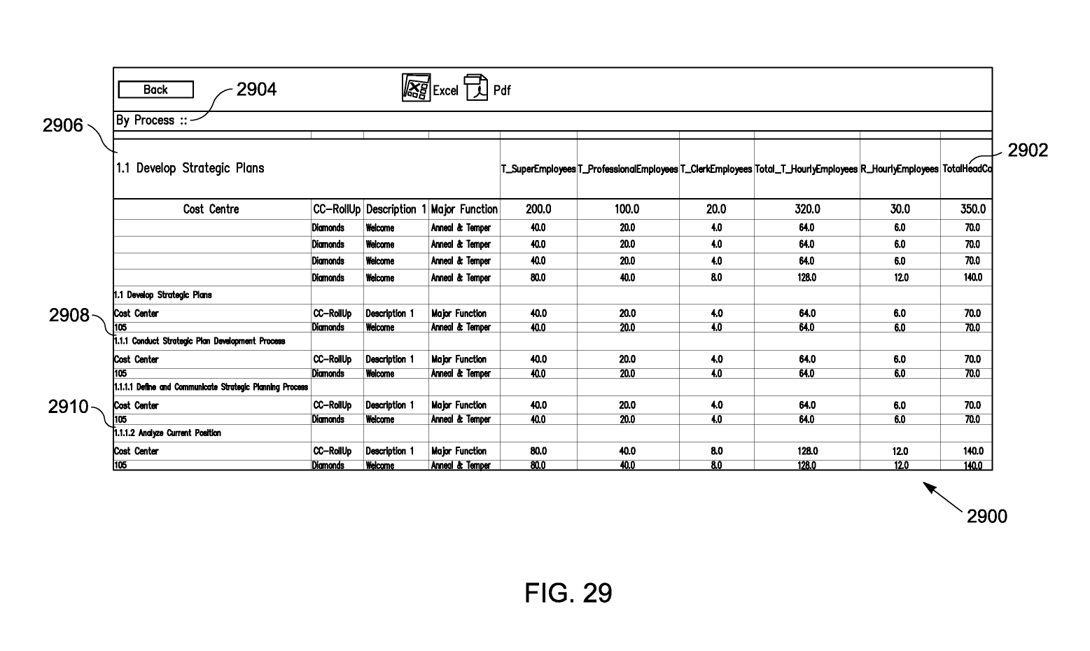

FIG. 29 is a screenshot of an example report view 2900 of cost center information 2902 by process 2904 for a selected sub-platform 2906, each selected capability 2908, process 2910, and sub-process for the sub-platform 2906. The report view 2900 reports allocated cost center information 2902 allocated to each capability, process, and sub-process for the sub-platform 2906.

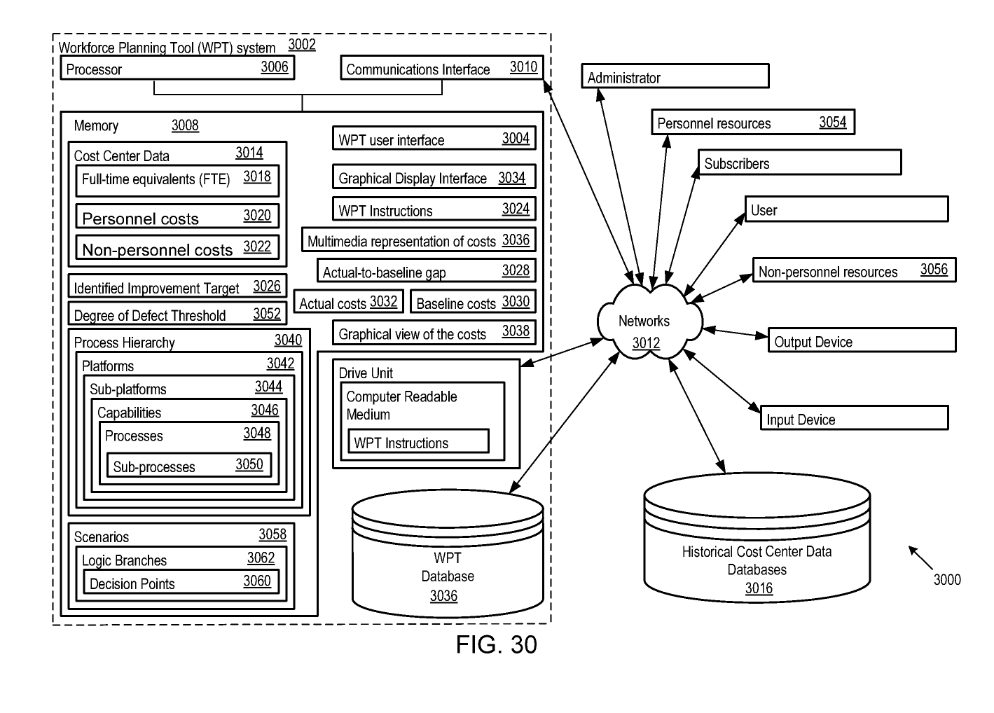

FIG. 30 is a block diagram of an example system configuration 3000 diagram. The WPT system configuration 3000 includes the WPT system 3002 that provides the WPT user interface 3004. The WPT system 3002 includes a processor 3006 coupled to a memory 3008 and communication interface 3010, in communication through a network 3012 (e.g., the Internet) with various components of the WPT system configuration 3000. The memory 3008 includes historical cost center data 3014 of the organization from a cost center data database 3016. The historical cost center data 3014 includes personnel full-time equivalents (FTE) 3018, personnel costs 3020, and non-personnel costs 3022. The memory 3008 further includes WPT instructions 3024 executable by the processor 3006, identified improvement target 3026, an actual-to-baseline gap 3028, baseline costs 3030, actual costs 3032, user input and interactions. The WPT system 3002 further includes a graphical display and graphical display interface 3034 configured to display a multimedia representation 3036 and graphical view 3038 of the costs according to the processes of the organization generated by the processor 3006. The memory 3008 includes a process hierarchy 3040 that includes a platform 3042, sub-platform 3044, capabilities 3046, processes 3048, and sub-processes 3050. The memory 3008 includes a degree of defect 3052 threshold that indicates a degree of efficient and/or effective execution of the processes 3048 executed by the personnel resources 3054 and the non-personnel resources 3056 of the organization. The processes 3048 and sub-processes 3050 include at least one scenario 3058 that includes an end-to-end path of decision points 3060 and logic branches 3062 that have corresponding costs. The memory 3008 also includes a process efficiency metric threshold that identifies the actual-to-baseline gap 3028 when the actual costs 3032 exceed the baseline costs 3030 by the process efficiency metric 3064 threshold, and a process effectiveness metric threshold that identifies the actual-to-baseline gap 3028 when processing errors for the processes of the organization exceed a particular number, a type of error that impacts quality of the processes of the organization, or a combination of the particular number and the type of error. The effectiveness of processes may be considered the degree of freedom from deficiencies, and examples include arising out of order entry errors, and reduce revenue loss due to “unauthorized deductions” recognized at the time of cash application. The first step is to baseline (calculate the present value of) these key measures of process effectiveness and then estimate the change in measures with new redesigned processes. The WPT system 3002 may store the data loaded into memory 3008 and/or calculated data in the WPT database 3036, where a structural representation of the process hierarchy and corresponding process hierarchy metadata may also be stored.

In a networked deployment, the computer system may operate in the capacity of a server or as a client user computer in a server-client user network environment, or as a peer computer system in a peer-to-peer (or distributed) network environment. The computer system may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system may be implemented using electronic devices that provide voice, video or data communication. Further, while a single computer system may be illustrated, the term “system” shall also be taken to include any collection of systems or sub-systems that individually or jointly execute a set, or multiple sets, of instructions to perform one or more computer functions.

As illustrated in FIG. 30, the computer system may include a processor, such as, a central processing unit (CPU), a graphics processing unit (GPU), or both. The processor may be a component in a variety of systems. For example, the processor may be part of a standard personal computer or a workstation. The processor may be one or more general processors, digital signal processors, application specific integrated circuits, field programmable gate arrays, servers, networks, digital circuits, analog circuits, combinations thereof, or other now known or later developed devices for analyzing and processing data. The processor may implement a software program, such as code generated manually (i.e., programmed).

The computer system may include a memory that can communicate via a bus. The memory may be a main memory, a static memory, or a dynamic memory. The memory may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory may include a cache or random access memory for the processor. Alternatively or in addition, the memory may be separate from the processor, such as a cache memory of a processor, the system memory, or other memory. The memory may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory may be operable to store instructions executable by the processor. The functions, acts or tasks illustrated in the figures or described herein may be performed by the programmed processor executing the instructions stored in the memory. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system may further include a display, such as a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor, or specifically as an interface with the software stored in the memory or in the drive unit.

Additionally, the computer system may include an input device configured to allow a user to interact with any of the components of system. The input device may be a number pad, a keyboard, or a cursor control device, such as a mouse, or a joystick, touch screen display, remote control or any other device operative to interact with the system.

The computer system may also include a disk or optical drive unit. The disk drive unit may include a computer-readable medium in which one or more sets of instructions, e.g. software, can be embedded. Further, the instructions may perform one or more of the methods or logic as described herein. The instructions may reside completely, or at least partially, within the memory and/or within the processor during execution by the computer system. The memory and the processor also may include computer-readable media as discussed above.

The present disclosure contemplates a computer-readable medium that includes instructions or receives and executes instructions responsive to a propagated signal; so that a device connected to a network may communicate voice, video, audio, images or any other data over the network. Further, the instructions may be transmitted or received over the network via a communication interface. The communication interface may be a part of the processor or may be a separate component. The communication interface may be created in software or may be a physical connection in hardware. The communication interface may be configured to connect with a network, external media, the display, or any other components in system 2400, or combinations thereof. The connection with the network may be a physical connection, such as a wired Ethernet connection or may be established wirelessly as discussed below. Likewise, the additional connections with other components of the system may be physical connections or may be established wirelessly. In the case of a service provider server, the service provider server may communicate with users through the communication interface.

The network may include wired networks, wireless networks, or combinations thereof. The wireless network may be a cellular telephone network, an 802.11, 802.16, 802.20, or WiMax network. Further, the network may be a public network, such as the Internet, a private network, such as an intranet, or combinations thereof, and may utilize a variety of networking protocols now available or later developed including, but not limited to TCP/IP based networking protocols.

The computer-readable medium may be a single medium, or the computer-readable medium may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium may include a solid-state memory such as a memory card or other package that houses one or more non-volatile read-only memories. The computer-readable medium also may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing may be constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

1. A method for identifying an improvement target for an organization, the method comprising:
capturing historical cost center data, including cost centers of the organization;
mapping the costs of the organization to a process hierarchy including corresponding processes of the organization by:
determining, from the historical cost center data, for each cost center, unit cost center data including: personnel full-time equivalents (FTE); personnel costs; and non-personnel costs;
allocating the unit cost center data to the corresponding processes of the organization;
calculating baseline costs to operate the processes of the organization with no processing errors;
calculating actual costs to operate the processes of the organization, using the unit cost center data allocation;
calculating an actual-to-baseline gap value equal to the difference between the baseline costs and the actual costs, wherein the actual-to-baseline gap value identifies the improvement target when the actual-to-baseline gap value exceeds a user configurable threshold.

2. The method of claim 1, wherein the historical cost center data of for each cost center comprises unit costs for personnel costs and non-personnel costs for the organization.

3. The method of claim 1, wherein the processes each comprise at least one scenario that includes a set of decision points and logic branches, wherein each logic branch of the at least one scenario includes a particular subset of the decision points.

4. The method of claim 3, wherein calculating the baseline costs to operate the processes of the organization with no processing errors comprises applying a degree of defect factor to the unit cost for the personnel and the non-personnel used to perform the processes of the organization.

5. The method of claim 1, wherein calculating the actual costs to operate the processes of the organization comprises applying the unit cost for the personnel and non-personnel used to perform the processes of the organization.

6. The method of claim 3, wherein the calculation of actual costs to operate the processes of the organization includes calculations of the actual costs for the at least one scenario, each decision point of the at least one scenario, and the logic branches of the at least one scenario.

7. The method of claim 6, further comprising: generating a representation of the costs according to the processes of the organization that reports the identified improvement target, wherein the representation of the costs according to the processes of the organization, include the baseline costs and actual costs to operate the processes of the organization decomposed for the at least one scenario, each decision point of the at least one scenario, and the logic branches of the at least one scenario.

8. The method of claim 1, where the user configurable threshold is a degree of defect threshold that indicates a degree of efficient or effective execution of the processes executed by the personnel resources and the non-personnel resources of the organization.

9. The method of claim 1, where the improvement target is identified when process errors for the processes of the organization exceed a degree of defect threshold of a particular number of errors, a type of error that impacts quality of the processes of the organization, or a combination of the particular number errors and the type of error.

10. A system for identifying an improvement target for an organization, the system comprising:
a memory coupled to a processor, the memory comprising:
historical cost center data of the organization;
instructions executable by the processor that when executed by the processor cause the processor to:
capture the historical cost center data of the organization;
map the costs of the organization to a process hierarchy comprising processes, where the historical cost center data is decomposed to allocate functional and departmental costs to the processes of the organization, further causes the processor to:
determine, from the historical cost center data, for each cost center, unit cost center data comprising: personnel full-time equivalents (FTE); personnel costs; and non-personnel costs, and
allocate the unit cost center data to the corresponding processes of the organization;
calculate baseline costs to operate the processes of the organization with no processing errors;
calculate actual costs to operate the processes of the organization, using the unit cost center data allocation;
identify an improvement target for an organization by identifying an actual-to-baseline gap by comparing the baseline costs to the actual costs, and the historical cost center data of the organization;
a communications interface configured to receive, via a network, the historical cost center data of the organization into the memory, and user inputs and interactions.

11. The system of claim 10, wherein the historical cost center data of the organization comprises unit costs for personnel costs and non-personnel costs to perform tasks for the organization.

12. The system of claim 10, wherein the processes each comprise at least one scenario that includes a set of decision points and logic branches, wherein each logic branch of the at least one scenario includes a particular subset of the decision points.

13. The system of claim 12, wherein calculating the baseline costs to operate the processes of the organization with no processing errors comprises applying a degree of defect factor to the unit cost for the personnel and the non-personnel used to perform the processes of the organization.

14. The system of claim 10, wherein calculating the actual process costs to operate the processes of the organization comprises applying the unit cost for the personnel and non-personnel used to perform the processes of the organization.

15. The system of claim 12, wherein the calculation of actual costs to operate the processes of the organization includes calculations of the actual costs for the at least one scenario, each decision point of the at least one scenario, and the logic branches of the at least one scenario.

16. The system of claim 15, further comprising:
a graphical display and graphical display interface configured to display a multimedia representation and graphical view of the costs according to the processes of the organization generated by the processor, wherein the representation of the costs according to the processes of the organization, include the baseline costs and actual costs to operate the processes of the organization decomposed for the at least one scenario, each decision point of the at least one scenario, and the logic branches of the at least one scenario.

17. The system of claim 1, where the actual-to-baseline gap value identifies the improvement target when the actual-to-baseline gap value exceeds a user configurable threshold.

18. The system of claim 1, where the process gap is identified when process errors for the processes of the organization exceed an effectiveness metric threshold of a particular number, a type of error that impacts quality of the processes of the organization, or a combination of the particular number and the type of error.

19. A computer readable medium comprising:
improvement target logic, when executed by a processor coupled to a memory, operable to:
capture historical cost center data, including cost centers of the organization;
map the costs of the organization to a process hierarchy including corresponding processes of the organization, where the historical cost center data is decomposed to allocate the costs to the processes of the organization by
determine, from the historical cost center data, for each cost center, unit cost center data including: personnel full-time equivalents (FTE); personnel costs; and non-personnel costs, and
allocate the unit cost center data to the corresponding processes of the organization;
calculate baseline costs to operate the processes of the organization with no processing errors;
calculate actual costs to operate the processes of the organization, using the unit cost center data allocation;
identify an improvement target for the organization by identifying an actual-to-baseline gap that exceeds a user configurable threshold by comparing the baseline costs to the actual costs, and the historical cost center data of the organization.

20. The computer readable medium of claim 19, wherein the historical cost center data of the organization comprises unit costs for personnel costs and non-personnel costs for the organization.

21. The computer readable medium of claim 19, wherein the processes each comprise at least one scenario that includes a set of decision points and logic branches, wherein each logic branch of the at least one scenario includes a particular subset of the decision points.

22. The computer readable medium of claim 21, wherein calculating the baseline costs to operate the processes of the organization with no processing errors comprises applying a degree of defect factor to the unit cost for the personnel and the non-personnel used to perform the processes of the organization.

23. The computer readable medium of claim 19, wherein calculating the actual process costs to operate the processes of the organization comprises applying the unit cost for the personnel and non-personnel used to perform the processes of the organization.

24. The computer readable medium of claim 21, wherein the calculation of actual costs to operate the processes of the organization includes calculations of the actual costs for the at least one scenario, each decision point of the at least one scenario, and the logic branches of the at least one scenario.

25. The computer readable medium of claim 24, wherein the improvement target logic, when executed by a processor, further causes the processor to generate a representation of the costs according to the processes of the organization, wherein the multimedia representation and the graphical view of the costs according to the processes of the organization, include the baseline costs and actual costs to operate the processes of the organization allocated and decomposed for the at least one scenario, each decision point of the at least one scenario, and the logic branches of the at least one scenario.

26. The computer readable medium of claim 19, wherein the actual-to-baseline gap value identifies the improvement target when the actual-to-baseline gap value exceeds the user configurable threshold.

27. The computer readable medium of claim 19, where the actual-to-baseline gap value is identified when processing errors for the processes of the organization exceed an effectiveness metric threshold by a particular number, a type of error that impacts quality of the processes of the organization, or a combination of the particular number and the type of error.
